(19) United States
(12) Patent Application Publication
(10) Pub. No.: US 2026/0143532 A1
(43) Pub. Date: May 21, 2026

(54) METHOD AND DEVICE FOR RANDOM ACCESS IN COMMUNICATION SYSTEM

(71) Applicant: SAMSUNG ELECTRONICS CO., LTD., Suwon-si (KR)

(72) Inventors: Xiaoli LIAN, Beijing (CN); Yunchuan YANG, Beijing (CN); Qi XIONG, Beijing (CN); Li YU, Beijing (CN); He WANG, Beijing (CN); Yizhou XU, Beijing (CN)

(73) Assignee: SAMSUNG ELECTRONICS CO., LTD., Suwon-si (KR)

(21) Appl. No.: 19/395,649

(22) Filed: Nov. 20, 2025

Related U.S. Application Data
(63) Continuation of application No. PCT/KR2025/019197, filed on Nov. 19, 2025.

(30) Foreign Application Priority Data
Nov. 20, 2024 (CN) 202411668478.1
Sep. 11, 2025 (CN) 202511300214.5

(51) Int. Cl. H04W 74/0833; H04B 17/318; H04L 5/00; H04W 76/38

(52) U.S. Cl. CPC H04W 74/0833; H04B 17/328; H04L 5/0044; H04W 76/38

(57) ABSTRACT

A method performed by a user equipment (UE) in a communication system, may include transmitting a random access request to a base station; receiving, from the base station, a response message in response to the random access request wherein the response message comprises information about a plurality of timing advance (TA) information entries and corresponding resource allocation information for a plurality of UEs; obtaining TA information and resource allocation information corresponding to the UE based on the response message; and transmitting uplink transmission to the base station based on the obtained TA information and the obtained resource allocation information corresponding to the UE.

### CROSS-REFERENCE TO RELATED APPLICATIONS

This application is a bypass continuation application of International Application No. PCT/KR2025/019197, filed on Nov. 19, 2025, which is based on and claims priority to Chinese Patent Application No.: 202411668478.1 filed on Nov. 20, 2024 in the the China National Intellectual Property Administration and Chinese Patent Application No.: 202511300214.5 filed on Sep. 11, 2025 in the the China National Intellectual Property Administration, the disclosures of which are incorporated by reference herein in their entireties.

### BACKGROUND

### 1. Field

The present disclosure relates to the technical field of wireless communication, and more specifically, to a physical random access channel (PRACH) detection method and methods for transmitting and receiving a random access response (RAR).

### 2. Description of Related Art

In order to meet the increasing demand for wireless data communication services since the deployment of fourth-generation (4G) communication systems, efforts have been made to develop improved fifth-generation (5G) or pre-5G communication systems. Therefore, 5G or pre-5G communication systems are also called “Beyond 4G networks” or “Post-LTE systems”.

In order to achieve a higher data rate, 5G communication systems are implemented in higher frequency bands, such as millimeter-wave (mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

5G systems incorporate advanced coding modulation (ACM), including hybrid frequency-shift keying (FSK) and quadrature amplitude modulation (QAM) (FQAM) and sliding window superposition coding (SWSC). Advanced multiple access technologies, such as filter bank multicarrier (FBMC), non-orthogonal multiple access (NOMA) and sparse code multiple access (SCMA), have also been developed.

### SUMMARY

According to an embodiment of the present disclosure, a method performed by a user equipment (UE) in a communication system is disclosed. The method may comprise transmitting a random access request to a base station. The method may comprise receiving, from the base station, a response message in response to the random access request wherein the response message comprises information about a plurality of timing advance (TA) information entries and corresponding resource allocation information for a plurality of UEs. The method may comprise obtaining TA information and resource allocation information corresponding to the UE based on the response message. The method may comprise transmitting uplink transmission to the base station based on the obtained TA information and the obtained resource allocation information corresponding to the UE.

The response message may further comprise at least one of: information of a number of the TA information entries; indication information of TA-related information, which indicates the UE to obtain corresponding TA-related information; random access preamble identification information; or a temporary cell radio network temporary identifier (T-CRNTI).

The obtaining the TA information and the resource allocation information corresponding to the UE may comprises obtaining TA-related information of the UE; and obtaining the TA information and the resource allocation information corresponding to the UE from the random access response based on the TA-related information. The TA-related information may comprise at least one of: a downlink pathloss between the UE and the base station; a receiving time and a transmitting time of a system information block; or signal strength information and threshold information.

The obtaining the TA information and the resource allocation information corresponding to the UE may comprise: determining TA estimation information of the UE based on the TA-related information; and determining, among the plurality of TA information entries included in the response message, TA information having a least difference from the TA estimation information as the TA information of the UE.

The method may comprise receiving the system information block transmitted from the base station, the system information block comprising the transmitting time.

The threshold information may comprise first threshold information and threshold offset information. The method may comprise determining multiple signal strength intervals based on the first threshold information and the threshold offset information.

The signal strength information may comprise reference signal received power, RSRP.

The plurality of TA information entries may comprise information about a first TA and information about a plurality of second TAs. The information about the first TA may indicate a reference TA value corresponding to the UE among the plurality of UEs. The information about the plurality of second TAs may indicate a relative TA value with respect to the first TA information for each UE among the plurality of UEs.

The determining the TA information having the least difference from the TA estimation information, may comprise: determining information about a third TA based on the TA estimation information and the first TA information; and determining the TA information of the UE based on a second TA having a least difference from the third TA among the plurality of second TAs.

The resource allocation information for the plurality of UEs may comprise uplink grant information and information about a plurality of demodulation reference signals (DMRSs) for the plurality of UEs.

The obtaining the TA information and the resource allocation information corresponding to the UE may comprise determining DMRS information corresponding to the UE from the information about the plurality of DMRSs based on the obtained TA information corresponding to the UE; and determining port information for transmitting uplink transmission based on the DMRS information corresponding to the UE.

The response message may comprise a random access response (RAR).

The response message may comprise downlink control information (DCI) comprising at least one of: information about a number of the plurality of TA information entries; indication information of TA-related information, which indicates the UE to obtain corresponding TA-related information; random access preamble identification information; or first TA information. The information about the number of the plurality of TA information entries may comprise the first TA information and a plurality of second TA information. The first TA information may indicate a reference TA value corresponding to the UE among the plurality of UEs. The second TA information indicates a relative TA value with respect to the first TA information for each UE among the plurality of UEs.

According to an embodiment of the present disclosure, a user equipment (UE) in a communication system is disclosed. The UE may comprise memory storing instructions; and at least one processor operably coupled to the memory. The instructions, when executed by the at least one processor individually or collectively, may cause the UE to perform operations. The operations may comprise transmitting a random access request to a base station. The operations may comprise receiving, from the base station, a response message in response to the random access request wherein the response message comprises information about a plurality of timing advance (TA) information entries and corresponding resource allocation information for a plurality of UEs. The operations may comprise obtaining TA information and resource allocation information corresponding to the UE based on the response message. The operations may comprise transmitting uplink transmission to the base station based on the obtained TA information and the obtained resource allocation information corresponding to the UE.

According to an embodiment of the present disclosure, a non-transitory computer-readable storage medium storing instructions is disclosed. The instructions when executed by at least one processor of a user equipment (UE) individually or collectively, may cause the UE to perform operations. The operations may comprise transmitting a random access request to a base station. The operations may comprise receiving, from the base station, a response message in response to the random access request wherein the response message comprises information about a plurality of timing advance (TA) information entries and corresponding resource allocation information for a plurality of UEs. The operations may comprise obtaining TA information and resource allocation information corresponding to the UE based on the response message. The operations may comprise transmitting uplink transmission to the base station based on the obtained TA information and the obtained resource allocation information corresponding to the UE.

### BRIEF DESCRIPTION OF DRAWINGS

The above and/or other aspects will be more apparent by describing certain example embodiments, with reference to the accompanying drawings, in which:

FIG. 1 illustrates an example wireless network according to various embodiments of the present disclosure;

FIG. 2A and FIG. 2B illustrate example wireless transmit and receive paths according to the present disclosure;

FIG. 3A illustrates an example user equipment (UE) according to the present disclosure;

FIG. 3B illustrates an example next generation node B (gNB) according to the present disclosure;

FIG. 4 illustrates an example flow diagram for artificial intelligence (AI)-based physical random access channel (PRACH) receiver detection algorithm in a multi-UE scenario according to embodiments of the present disclosure;

FIGS. 5 to 7 illustrate schematic diagrams of the determination process of candidate multi-user signal clusters according to embodiments of the present disclosure;

FIG. 8 illustrates an example flow chart for contention-based access in a multi-UE scenario according to embodiments of the present disclosure;

FIG. 9 illustrates a schematic diagram of random access response (RAR) information being configured only in medium access control (MAC) RAR protocol data unit (PDU) according to an embodiment of the present disclosure, in which 2 UEs are detected for only one random access preamble identifier (RAPID), demodulation reference signal (DMRS), and timing advance (TA) obtaining indication information (shown as TA flag in the figure) are configured, the timing advance command (TAC) field is configured with the absolute timing advance (TA) values (TA1, TA2 shown in the figure);

FIG. 10 illustrates a schematic diagram of RAR information being configured only in MAC RAR PDU according to an embodiment of the present disclosure, wherein the figure illustrates that 2 UEs are detected for one RAPID, DMRS, and TA obtaining indication information (shown as TA flag in the figure) are configured, the TAC field is configured with the reference TA (reference TA shown in the figure) and relative TA (relative TA1 shown in the figure);

FIG. 11 illustrates a schematic diagram of RAR information being jointly configured in DCI 1_0 and MAC RAR PDU according to an embodiment of the present disclosure, where DCI 1_0 carries RAPID, 2 UEs are detected for only one RAPID, DMRS, and TA obtaining indication information (shown as TA flag in the figure) are configured in the MAC PDU, and the TAC field is configured with the reference TA and relative TA;

FIG. 12 illustrates a schematic diagram of RAR information being jointly configured in DCI 1_0 and MAC RAR PDU according to an embodiment of the present disclosure, where DCI 1_0 carries RAPID, reference TA and UE number. The figure illustrates that 2 UEs are detected for one RAPID. UEs, DMRS, and TA obtaining indication information (shown as TA flag in the figure) are configured in the MAC PDU, and the TAC field is configured with relative TA value;

FIG. 13 illustrates a schematic diagram of RAR information being jointly configured in DCI 1_0 and MAC RAR PDU according to an embodiment of the present disclosure, where DCI 1_0 carries RAPID, UE number, reference TA and absolute threshold (shown as reference signal received power (RSRP) threshold in the figure), the figure illustrates that 2 UEs are detected for one RAPID, DMRS, TA obtaining indication information (shown as TA flag in the figure), and threshold offset information (shown as RSRP-offset in the figure) are configured in the MAC PDU, and the TAC field is configured with relative TA value;

FIG. 14 illustrates a schematic diagram of RAR information being jointly configured in DCI 1_0 and MAC RAR PDU according to an embodiment of the present disclosure, where DCI 1_0 carries RAPID, UE number, reference TA, and TA obtaining indication information (shown as TA flag in the figure), the figure illustrates that 2 UEs are detected for one RAPID, DMRS is configured in the MAC PDU, and the TAC field is configured with a relative TA value.

FIG. 15 illustrates a schematic diagram of RAR information being jointly configured in DCI 1_0 and MAC RAR PDU according to an embodiment of the present disclosure, where DCI 1_0 carries RAPID, UE number, reference TA, TA obtaining indication information (shown as TA flag in the figure), absolute threshold information (shown as RSRP threshold in the figure), the figure illustrates that 2 UEs are detected for one RAPID, DMRS, and threshold offset information (shown as RSRP-offset in the figure) are configured in the MAC PDU, and the TAC field is configured with the relative TA value.

FIG. 16 illustrates a schematic diagram of RAR information being jointly configured in DCI 1_0 and MAC RAR PDU according to an embodiment of the present disclosure, where DCI 1_0 carries RAPID and absolute threshold information (shown as RSRP threshold in the figure). The figure illustrates that 2 UEs are detected for one RAPID, DMRS, UE number are configured in the MAC PDU, and the TAC field is configured with reference TA and relative TA values. In addition, in this design, DMRS is used for the base station to identify overlapping uplink (UL) grant resources; all UEs identified for this RAPID have the same UL grant; the temporary cell radio network temporary identifier (T-CRNTI) field indicates the T-CRNTI of a reference UE.

FIG. 17 illustrates a schematic diagram of a MAC PDU containing RAR in a multi-UE scenario according to an embodiment of the present disclosure;

FIG. 18 illustrates a schematic structural diagram of a user equipment (UE) according to at least one embodiment of the present disclosure;

FIG. 19 illustrates a schematic structural diagram of a network node according to at least one embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The various embodiments of the present disclosure may be applied to various communication systems, such as: global system for mobile communications (GSM) system, code division multiple access (CDMA) system, broadband code division multiple access (WCDMA) system, general packet radio service (GPRS), long term evolution (LTE) system Frequency division duplex (FDD) systems, time division duplex (TDD) systems, universal mobile telecommunications systems (UMTS), global interoperability for microwave access (WiMAX) communication systems, fifth generation (5G) systems or new wireless (NR) systems, etc. In addition, the various embodiments of the present disclosure may be applied to future oriented communication technologies.

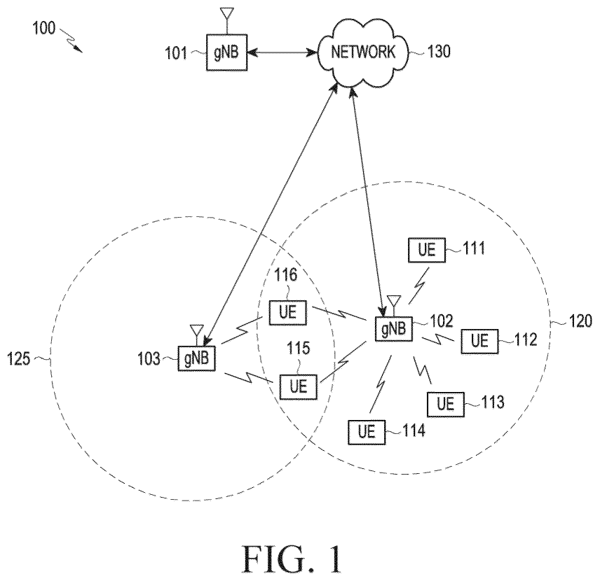

FIG. 1 illustrates an example wireless communication system 100 according to various embodiments of the present disclosure. The embodiment of the wireless communication system 100 shown in FIG. 1 is for illustration only. Other embodiments of the wireless communication system 100 may be used without departing from the scope of the present disclosure.

The wireless communication system 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, another term, such as a wireless communication node that may encompass or correspond to “base station,” “access point,” or a (mobile) WiFi hotspot may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smartphone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 may communicate with each other and with UEs 111-116 using 5G, Long Term Evolution (LTE), LTE-A, WiMAX or other advanced wireless communication technologies.

The dashed lines illustrate approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless communication system 100, various changes may be made to FIG. 1. The wireless communication system 100 may include any number of gNBs and any UE number in any suitable arrangement, for example. Furthermore, gNB 101 may directly communicate with any UE number and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

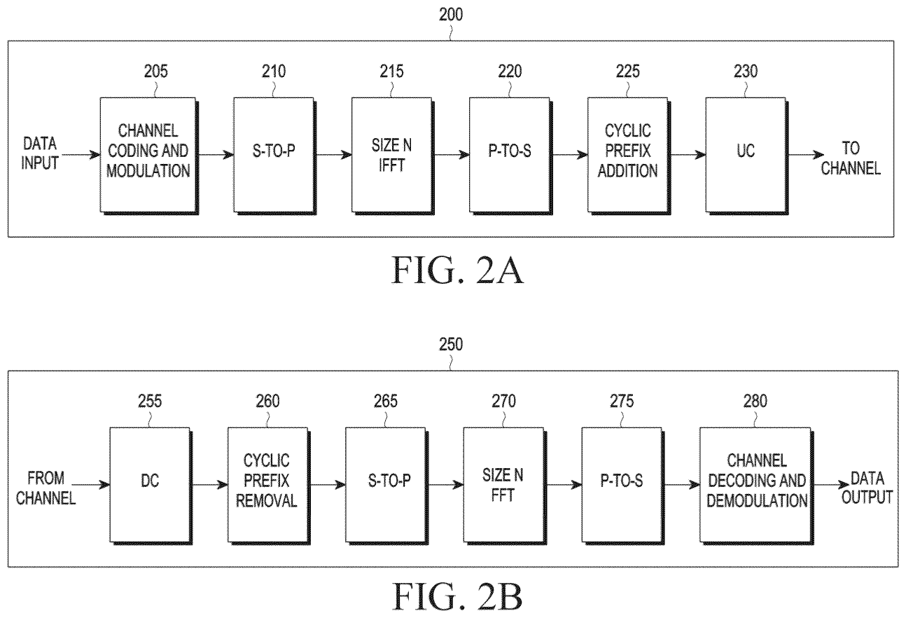

FIGS. 2A and 2B illustrate example wireless transmission and reception paths according to the present disclosure. In the following description, the transmission path 200 is described as being implemented in a gNB, such as gNB 102, and the reception path 250 is described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before up-conversion to the RF frequency.

The RF signal transmitted from gNB 102 is received by UE 116 after passing through the wireless channel, where signal processing operations are performed in reverse to those at gNB 102. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

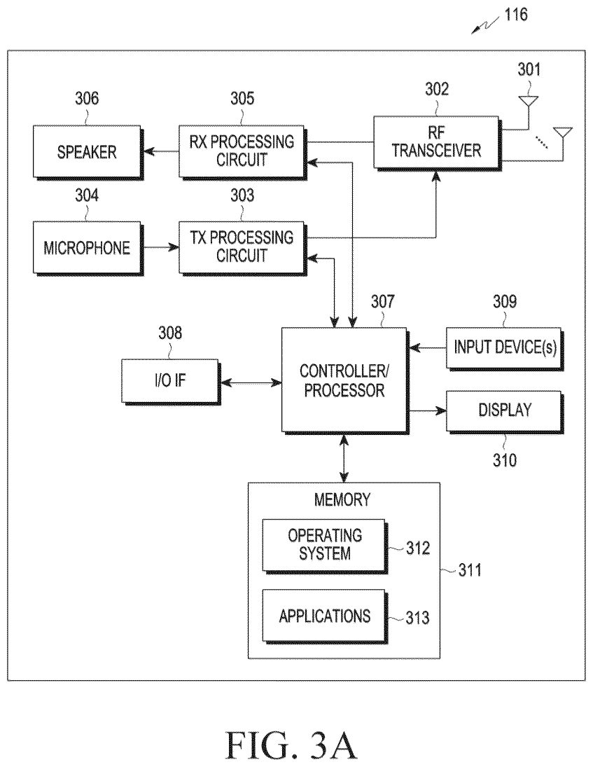

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 301, a radio frequency (RF) transceiver 302, a transmission (TX) processing circuit 303, a microphone 304, and a reception (RX) processing circuit 305. UE 116 also includes a speaker 306, a controller/processor 307, an input/output (I/O) interface 308, an input device(s) 309, a display 310, and a memory 311. The memory 311 includes an operating system (OS) 312 and one or more applications 313.

The RF transceiver 302 receives an incoming RF signal transmitted by a gNB of the wireless communication system 100 from the antenna 301. The RF transceiver 302 down-converts the incoming RF signal to generate an intermediate frequency (IF) or baseband signal. The IF or baseband signal is transmitted to the RX processing circuit 305, where the RX processing circuit 305 generates a processed baseband signal by filtering, decoding and/or digitizing the baseband or IF signal. The RX processing circuit 305 transmits the processed baseband signal to speaker 306 (such as for voice data) or to controller/processor 307 for further processing (such as for web browsing data).

The TX processing circuit 303 receives analog or digital voice data from microphone 304 or other outgoing baseband data (such as network data, email or interactive video game data) from controller/processor 307. The TX processing circuit 303 encodes, multiplexes, and/or digitizes the outgoing baseband data to generate a processed baseband or IF signal. The RF transceiver 302 receives the outgoing processed baseband or IF signal from the TX processing circuit 303 and up-converts the baseband or IF signal into an RF signal transmitted via the antenna 301.

The controller/processor 307 may include one or more processors or other processing devices and execute the OS 312 stored in the memory 311 in order to control the overall operation of UE 116. For example, the controller/processor 307 may control the reception of forward channel signals and the transmission of backward channel signals through the RF transceiver 302, the RX processing circuit 305 and the TX processing circuit 303. In some embodiments, the controller/processor 307 includes at least one microprocessor or microcontroller.

The controller/processor 307 is also capable of executing other processes and programs residing in the memory 311, such as operations for channel quality measurement and reporting for systems with 2D antenna arrays as described in embodiments of the present disclosure. The controller/processor 307 may move data into or out of the memory 311 as required by an execution process. In some embodiments, the controller/processor 307 is configured to execute the application 313 based on the OS 312 or in response to signals received from the gNB or the operator. The controller/processor 307 is also coupled to an I/O interface 308, where the I/O interface 308 provides UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of UE 116 may input data into UE 116 using the input device(s) 309. The display 310 may be a liquid crystal display or other display capable of presenting text and/or at least limited graphics (such as from a website). The memory 311 is coupled to the controller/processor 307. A part of the memory 311 may include a random access memory (RAM), while another part of the memory 311 may include a flash memory or other read-only memory (ROM).

Although FIG. 3A illustrates an example of UE 116, various changes may be made to FIG. 3A. For example, various components in FIG. 3A may be combined, further subdivided or omitted, and additional components may be added according to specific requirements. As a specific example, the controller/processor 307 may be divided into a plurality of processors, such as one or more central processing units (CPUs) and one or more graphics processing units (GPUs). Furthermore, although FIG. 3A illustrates that the UE 116 is configured as a mobile phone or a smartphone, UEs may be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 may have the same or similar configuration. However, a gNB has various configurations, and FIG. 3B does not limit the scope of the present disclosure to any specific implementation of a gNB. It should be noted that gNB 101 and gNB 103 may include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of gNB 102. For example, the controller/processor 378 may control the reception of forward channel signals and the transmission of backward channel signals through the RF transceivers 372a-372n, the RX processing circuit 376 and the TX processing circuit 374. The controller/processor 378 may also support additional functions, such as higher-level wireless communication functions. For example, the controller/processor 378 may perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 may move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, gNB 102 may include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples may be made without departing from the scope of the present disclosure.

In the new radio (NR) communication system, a cell supports up to 64 preambles, which are used for contention-based random access (CBRA) and contention-free random access (CFRA). The resources used for CBRA may be further divided into group A and group B, and the difference between different groups is mainly in the size of the information used to transmit message 3 (Msg3). Even in CFRA scenarios, e.g., in case of going from RRC-Inactive state to RRC-Connected state, or beam recovery, or when downlink data arrives for access triggered by PDCCH order or handover, CFRA will automatically be switched to CBRA if dedicated CFRA resources are not configured or exhausted. In addition, more new random access scenarios are introduced in NR, including RRC connection recovery, requesting other system information, beam failure recovery, etc. Different scenarios share the access resource pool, resulting in fewer resources for a specific CBRA.

Assuming that multiple UEs in the same cell initiate access requests in the same physical random access channel (PRACH) or PRACH Occasion (RO, random access occasion), the available sequence resource size of the cell is r, and there are k UEs accessing the same random access resource at the same time. When r=64, k=64, the collision probability of k UEs accessing the same access resource at the same time is as high as 26.4%; when k=r/2, the collision probability may reach 10%.

In the future, as the number of connected users increases sharply, the probability of collision will increase significantly, resulting in increased access delay and increased UE power consumption, which greatly affects user experience. Access collision will become an important issue that needs to be solved urgently.

Embodiments of the present disclosure relate to a detection method performed by a base station (BS) based on artificial intelligence (AI) for random access preamble related information during a UE random access procedure and configuration scheme for transmitting and receiving random access response (RAR).

The following will first explain the detection algorithm and protocol process.

In communication systems, the detection algorithms for PRACH channel are mainly for single UE access detection, including methods based on legacy threshold judgment and methods based on AI detection.

The legacy threshold-based detection solution firstly correlates the received PRACH preamble with the locally generated Zadoff-Chu (ZC) sequence to obtain the power delay profile (PDP). The search window (SW) in the PDP may be specified based on the preamble-related information exchanged between the BS and the UE through higher layer signaling. If the maximum value, e.g., peak value, of the PDP within the SW exceeds a preset threshold, a random access preamble ID (RAPID) and a timing advance (TA) are identified as timing information corresponding to the specific SW.

The AI-based solution first performs TA pre-compensation on the time domain results after IFFT transformation of the frequency domain correlation results to obtain the complex power delay profile (complex PDP, CDP), and then sends the CDP into a binary classification AI model for PRACH preamble detection.

For a multi-UE scenario, when multiple UEs in the cell select the same preamble and initiate access on the same time-frequency resource, the BS will assume that the preamble is transmitted from a certain UE and carry important attributes of the preamble in the RAR fed back to the UE, including RAPID, temporary CRNTI (Temporary Cell Radio Network Temporary Identifier (CRNTI), T-CRNTI) and uplink scheduling information (for example, uplink grant (UL Grant)), etc. Assuming that multiple UEs have received this RAR, they will consider this RAR to be transmitted to themselves. Each UE will transmit message 3 (MSG3) to the BS according to the allocation of UL Grant, where each UE carries its own dedicated identification number (for example, 5G System-Temporary Mobile Subscriber Identifier (5GS-TMSI) or random number). In this case, the BS also needs to use the same T-CRNTI to receive MSG3 at the same or corresponding time-frequency location. For MSG3 transmitted by each UE, it is likely that none of them may be received by the BS (due to interference between UEs), and in this case the access requests of these UEs fail. Assuming that the BS receives the MSG3 of at least one UE, the BS selects the identification number of one UE of the UEs according to its own algorithm criteria, and then transmits the unique identification number of the UE together with other radio resource configuration information to the UE through message 4 (MSG4). Only the UE whose identification number included in MSG4 is consistent with the identification number carried in MSG3 by itself is the normally accessed UE, while the access requests of other UEs fail. The conflict is resolved in such way.

Legacy threshold-based solution is suitable for PRACH preamble detection in high signal noise ratio (SNR) situations. This is mainly due to the ideal correlation property of ZC sequences. However, in low SNR situations, relying on PDP correlation power for PRACH preamble detection has inherent limitations, such as noise estimation error, limited fixed threshold presetting, etc., which may result in non-negligible false alarm and/or miss detection. In addition, in some practical networks, the detector may miss detection of the preamble due to the PDP peak value of the real PRACH signal being below a preset threshold caused by channel pathloss and/or the Doppler effect in high-speed scenarios. In addition, cell interference and the multipath effect may further complicate the detection of PRACH signals. In a multi-UE scenario, the above problems are further worsened due to mutual interference between multiple UEs.

For example, for the detection of PRACH signals, AI-based solutions have phase bias in the pre-compensation due to TA estimation itself being inaccurate at low SNR, which may deteriorate the detection performance of the AI model. On the other hand, due to the numerous formats and parameters in PRACH preamble sequence configuration, the search window (SW) lengths in different configurations are different, so different configurations and different models are required, and the complexity is too high and does not have generalization.

In some implementations, for multi-UE conflict scenarios, AI-based solutions usually focus on conflict avoidance, such as resource configuration, planning, etc. in the cell deployment stage, so they cannot fundamentally solve the conflict problem.

Moreover, in a multi-UE scenario, the base station may usually only respond to the access of one UE at most, and the conflict needs to be resolved until at MSG4 of the access process.

One or more embodiments of the present disclosure provide an AI-based random access detection solution in a multi-UE collision scenario in a wireless communication system. In addition, one or more embodiments of the present disclosure also provide a random access response (RAR) design and corresponding random access procedures for both transmitting and receiving parties. For example, in an aspect, the one or more embodiments provide a method including: applying a mixture-of-expert (MoE)-based feature enhancer according to the PDP signal amplitude distribution characteristics to obtain an enhanced PDP signal; perform adaptive combining based on similarity between multiple antennas, multiple symbols and/or multiple pseudo-peak windows to obtain a target window; identifying candidate multi-user signal clusters by analyzing the signal amplitude characteristics of the target window, and constructing a feature engineering to perform AI-based physical random access channel (PRACH) detection. Among them, the AI-based PRACH detection algorithm and its related preprocessing are used to replace the legacy threshold detection algorithm and deployed in the physical layer. In another aspect, the present disclosure provides designing BS-side RAR transmission and UE-side RAR reception solutions based on detection results. In an implementation, DCI_1_0 scrambled based on RA-RNTI and PDSCH RAR is included. Through the method and RAR design provided by the present disclosure, it is possible to better ensure that conflicts are at least partially or completely resolved in the first step of the random access phase, and pioneered to achieve simultaneous access of multiple UEs under conflicts. In addition, embodiments according to the present disclosure also provide a clustering-based adaptive detection window combining solutions for multi-antenna, multi-symbol, and high speed train (HST) scenarios. Through the methods provided by the present disclosure, access performance may be improved (for example, the probability of miss detection and/or false alarm is reduced). Performance improvement may, on the one hand, improve access delay, increase access capacity, and save access resources at the same time. On the UE side, the user experience may be greatly improved and the power consumption on the UE side may be reduced.

According to one aspect of the present disclosure, an AI-based access detection algorithm in a multi-UE conflict scenario is provided, with the purpose of solving the detection of conflicting UEs in a multi-UE scenario. According to another aspect of the present disclosure, a random access response (RAR) design is provided, including RAR generation and transmission related processes on the base station side, and RAR reception and processing related processes on the UE side. Through the design of transmitting and receiving solutions of random access response, it may better ensure the simultaneous access of conflicting UEs in a multi-UE scenario.

In one aspect, a method according to the present disclosure may apply a MoE-based feature enhancer to enhance the PDP signals, and suppress noise while enhancing amplitude of the PDP signals.

In another aspect, a method according to the present disclosure may identify candidate multi-user signal clusters, perform signal-noise separation, and estimate noise power.

In another aspect, a method according to the present disclosure may evaluate the similarity between multiple pseudo-peak windows in high-speed scenarios (e.g., High Speed Train (HST) scenarios), enabling adaptive combining between multiple windows. By combining detection windows with similarity as the target window, the SNR performance and detection performance may be improved; in addition, for detection windows with low similarity, only the detection window where the maximum PDP or CDP amplitude is located may be retained as the target window to improve the false alarm performance.

In another aspect, a method according to the present disclosure may evaluate the similarity between multiple receiving antennas in multi-antenna scenarios to achieve adaptive combining between multiple antennas. By combining antennas with similarity as the target antenna, the SNR performance and detection performance may be improved; in addition, only the antenna with the maximum PDP or CDP amplitude value may be retained as the target antenna for antennas with low similarity to improve false alarm performance.

In another aspect, a method according to the present disclosure may evaluate the similarity between multiple received symbols in a multi-symbol scenario to achieve adaptive combining between multiple symbols. By combining symbols with similarity as the target symbol, the SNR performance and detection performance may be improved; in addition, for symbols with low similarity, only the symbol where the PDP or CDP amplitude is of the maximum value may be retained as the target symbol to improve the false alarm performance.

In yet another aspect, a method according to the present disclosure may identify channel-related features and candidate user signal clusters within each target window. Identifying channel-related features includes: multipath feature identification, oversampling pseudo-peak identification, signal-noise feature separation, and so on. Candidate user signal clusters refer to time windows in which signals transmitted by UEs might exist. Through the method provided by this disclosure, the efficiency of AI-based detection may be improved and the detection complexity and/or model implementation complexity may be reduced.

In yet another aspect, a method according to the present disclosure may construct generalization-based feature engineering and propose confidence-based output judgments, thereby improving the robustness of the detection results.

In yet another aspect, a method according to the present disclosure may solve the problem of multi-UE simultaneous access in a multi-UE conflict scenario, and the specific method will be described in detail below.

In yet another aspect, a method according to the present disclosure may solve the problem of multi-UE simultaneous access in a multi-UE conflict scenario, increase access capacity, and provide the possibility of canceling restriction sets in future HST scenarios.

In yet another aspect, a method according to the present disclosure may design the PDCCH and PDSCH MSG2 on the BS side for a multi-UE scenario, and also provide a method for the UE side to distinguish the important attribute parameter sets of the preamble belonging to itself.

The method of the embodiment of the present disclosure will be described in more detail below from two parts, one of which is the AI-based PRACH detection algorithm and the other part is the design of transmitting and receiving RAR.

For example, the overall procedure of the AI-based multi-user detection solution is as follows:
The BS receives PDP signals;
The BS first identifies candidate multi-user signal clusters by analyzing the amplitude characteristics of the PDPs. Feature selection is then performed on the candidate multi-user signal clusters and the selected features are fed into an AI-based classifier that outputs whether a UE is present for each RAPID. The AI-based classifier may be implemented as a fully connected neural network-based classifier trained to classify whether a UE is present for each RAPID based on enhanced PDP features, a convolutional neural network (CNN)-based classifier configured to interpret the PDP features as a two-dimensional image (e.g., time×antenna index×frequency) to detect multi-user patterns, or a recurrent neural network (RNN) or long short-term memory (LSTM) network to capture temporal dependencies in the PDP sequence, or a transformer-based classifier configured to receive PDP feature vectors as input, and output a set of probabilities indicating UE presence per RAPID.

For each RAPID where a UE is determined to be present, the base station calculates the corresponding TA using the time information of the first peak in the associated user signal cluster data.

Furthermore, if the PRACH involves reception over multiple symbols or multiple antennas, or in high-speed scenarios, the BS will perform dynamic combination of the received signals in the time-space domain based on the similarity of the PDPs before identifying candidate user signal clusters.

In addition, in order to make the signal characteristics of multi-user signal clusters more obvious, a MoE feature enhancer based on the signal amplitude distribution characteristics is applied to enhance the characteristics before dynamic combining.

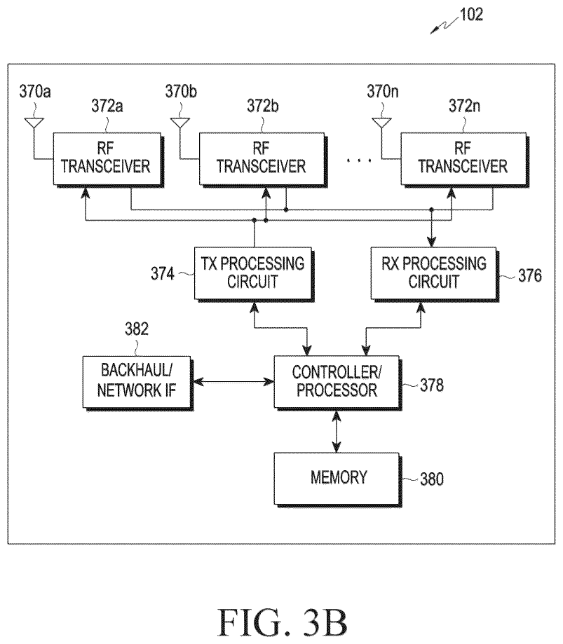

The AI-based PRACH detection algorithm according to an embodiment of the present disclosure, as shown in FIG. 4, mainly includes at least some of the following steps:

Step S0, receive PDP signals; for example, the PDP signals are received from each antenna and/or each symbol.

Step S1, apply the MoE-based feature enhancer according to distribution characteristics of signal amplitudes. For example, different enhancers may be applied to different incoming PDP signals to enhance characteristics; specifically, it is first identified whether the channel is multipath or single path, and then an enhancer is selected based on measured characteristics of the signals, optionally, such as signal-to-noise ratio, fourth order moment, maximum delay spread and the like. For an AWGN channel, according to a comparison result of the measured SNR with a preset threshold, it is determined which enhancers to use, and the order in which the enhancers are used. In one or more embodiments, the MoE feature enhancer may include a feature extraction layer configured to derive amplitude- and phase-related statistics from each PDP (e.g., mean power, peak-to-average ratio, and delay spread), a plurality of subnetworks, each trained to specialize in enhancing certain signal characteristics corresponding to specific propagation environments or interference conditions (e.g., low SNR, overlapping user peaks, Doppler spread), a gating network configured to assign weights to each subnetwork based on the input PDP characteristics. The MoE feature enhancer may fuse the outputs of the plurality of subnetworks into a unified enhanced feature representation, which is then passed to the AI-based classifier.

Optional step S11: determine whether the signals involve multiple antennas or multiple symbols or whether they are signals in a high-speed scenario.

Step S2, perform dynamic combination based on PDP similarity in time-space domain on received PDP signals for high speed and/or multi-antenna and/or multi-symbol scenarios. For example, first evaluate the similarity between PDP signals, and dynamically combine each PDP signal based on the evaluation result; if the judgment result of the optional step is a non-high-speed scenario and a single-antenna single-symbol scenario, proceed directly to step S3.

Similarity evaluation of multiple pseudo-peak windows related to the PDPs of the signals in a high speed (e.g., high speed train (HST)) scenario;

In multi-antenna or multi-symbol scenarios, evaluate the similarity of the PDP signals between each antenna or symbol;

Combine signals corresponding to pseudo-peak windows, multi-antenna or multi-symbol with similarity to obtain the target window, target antenna or target symbol;

Step S3, perform candidate user signal cluster identification based on PDP amplitude characteristics. For example, identify candidate user signal clusters for each search window (SW). For example, perform user signal cluster identification on each target window through data preprocessing to obtain candidate user signal clusters. In addition, the signal-to-noise separation point and, optionally, the noise power may also be obtained;

Step S4, perform necessary feature selection for user signal cluster identification. For example, construct an initial feature engineering, such as considering user signal cluster information, cell radius, etc., construct a feature engineering containing user signals through data preprocessing;

Step S5, perform unified feature selection to achieve generalization. The unified feature selection may be a common feature selection procedure that adapts to different PRACH scenarios (e.g., varying subcarrier spacing, symbol durations, number of antennas, or user densities) while maintaining consistent feature representation and generalization capability. For example, based on the initial feature engineering, a unified feature engineering for each scenario configuration is constructed. For example, considering the current network environment and the diverse configuration of PRACH channels, perform feature screening and/or feature reconstruction based on candidate user signal clusters, and design AI-based PRACH detection solution with generalization;

Step S6, perform feature selection based on scalar features of PDPs for AI classifier to identify whether RAPID is present. For example, perform AI-based PRACH detection;

Step S7, perform TA detection. For example, perform RAPID and TA detection, and sort and report based on the detection results. For example, the results of feature screening and/or feature reconstruction may be input into the AI-based PRACH detection model, and information such as RAPID and TA etc. may be obtained by designing the confidence-based detection output.

Embodiments of the present disclosure also provide design on transmitting and receiving RAR, including design on transmitting RAR at BS side and design on receiving RAR at UE side. In the design on transmitting RAR on the BS side, the composition, form and carrying location of information for multiple UEs are mainly considered. In the design on receiving RAR on the UE side, how the UE selects its own parameters and information is mainly considered.

The principles and solutions of the present embodiments will now be described with reference to several illustrative aspects.

### Example Aspect One

In this example aspect, a method for detecting preamble-related information in a random access procedure of a UE performed by a BS based on an Artificial Intelligence (AI) model in a communication system according to the present embodiment is introduced. The detection of preamble-related information may include, for example, obtaining information related to the index of the preamble for random access by the UE and configuration information used by the UE to carry data transmitted on the uplink traffic channel scheduled by the RAR (for example, physical uplink shared channel (PUSCH), and the timing advance (TA) information for transmitting, and the process includes the following multiple stages or modes or operations:
Step 1: UE obtains configuration information for random access to transmit physical random access channel (PRACH) based on the received system information block (System Information Block 1, SIB1), where the configuration information for PRACH includes: PRACH configuration index (PRACH-Configuration index), PRACH frequency domain resource starting location for transmission (Msg 1-Frequency Start), zero correlation zone configuration (zerocorrelationzoneconfig), restricted set configuration information (restrictedSetConfig), root sequence indication information (RootSequence index), etc. Based on the obtained configuration information for PRACH, the UE determines the preamble sequence set, the root sequence number in the set type and the cyclic shift offset N_{CS}, and generates and transmits the corresponding preamble on the configured time-frequency resource.
Step 2: based on the received time domain signal of the preamble, the BS obtains time domain detection signals within N search windows (or referred to as detection windows), where N represents the maximum number of search windows, corresponds to the number of candidate preambles in the cell, and may be a predefined value or a preconfigured value, for example, N=64. Its process includes the following multiple phases or modes or operations:
Step 2.1: the BS performs time domain front-end processing on the received time domain signal of the preamble, and obtains the frequency domain signal of the preamble Yₙ (n=0, 1, . . . , L_{RA}−1) based on the configured frequency domain location information of the preamble signal and PRACH configuration index, L_{RA} indicating the length of the preamble sequence, for example, L_{RA} may be 139, 839, 1157, or other values. The time domain front-end processing operations include removing the cyclic prefix part (cyclic prefix, CP) of the preamble sequence, down-sampling, L_{RA}-point Discrete Fourier Transform (DFT) and/or symbol combining operations.
Step 2.2: the BS performs a correlation operation on the obtained frequency domain preamble sequence Yₙ and the pre-generated U frequency domain preambles X_{n,u} to obtain U frequency domain correlation sequence Z_{n,u} after correction. The correlation operation may be expressed as:

$${Z}_{n , u} = {Y}_{n} \cdot {X}_{n , u}^{*} , n = 0 , 1 , … , {L}_{R A} - 1 , u = 0 , 1 , … , U$$

Where (·)* denotes the conjugate operation of a complex number, e.g. denoting

$${X}_{n} = Real ( {X}_{n} ) + j * i m a g ( {X}_{n} ) , then {X}_{n}^{*} = Real ( {X}_{n} ) - j * i m a g ( {X}_{n} ) .$$

U indicates the number of configured preamble root sequences. For example, the maximum of U may be configured as 64.

Based on the obtained frequency-domain correlation sequence Z_{n,u}, N_{ifft}−L_{RA} zero elements are added to obtain zero-element-padded frequency-domain correlation sequence

$${Z}_{u}^{′} ( {Z}_{u}^{′} = [ {Z}_{n , u} , 0 … , 0 ] ) n = 0 , 1 , … , {L}_{R A} - 1 ,$$

and an N_{ifft}-point Inverse Fast Fourier Transform (IFFT) is performed to obtain time-domain correlation signals xᵤ of U preambles.

$${x}_{u} [ l ] = IFFT ( {Z}_{u}^{′} ) ( l = 0 , 1 , … , {N}_{ifft} - 1 , u = 0 , 1 , … , U )$$

Based on the configured cyclic shift N_{cs}, preamble length L_{RA}, and the number of points Fourier transform N_{ifft}, the preamble x_{i,u}[j] in the i-th search window for the root sequence is obtained,

$${x}_{i , u} [ j ] = {x}_{u} [ j ] ( j = i * Nsw , … ( i + 1 ) * Nsw - 1 ) , i = 0 , … , ⌊ \frac{{L}_{R A}}{Ncs} ⌋ - 1$$

where the length of each search window N_{SW} is expressed as:

$$Nsw = Ncs * {N}_{ifft} / {L}_{R A}$$

The number of search windows corresponding to each root sequence is

$$⌊ \frac{{L}_{R A}}{Ncs} ⌋ ,$$

the number of root sequences required to generate N search windows is

$$U = ceil ( \frac{N}{⌊ \frac{{L}_{R A}}{Ncs} ⌋} ) .$$

Obtaining the power delay profile (PDP) of the preamble signal within each detection window, wherein the PDP within the i-th search window is expressed as:

$${P}_{i , u} [ j ] = {\vert {x}_{i , u} [ j ] \vert}^{2} ( j = i * Nsw , … ( i + 1 ) * Nsw - 1 ) , i = 0 , … , ⌊ \frac{{L}_{R A}}{Ncs} ⌋ - 1$$

Step 3: apply a MoE-based feature enhancer based on the distribution characteristics of signal amplitudes within each detection window, apply different enhancers to different input PDP signals, and obtain enhanced PDP signals.
Step 4: for multi-antenna or multi-symbol scenario, according to the number of receiving antennas and the number of OFDM symbols corresponding to PRACH configuration, the BS selects the antenna and symbol where the PDP signal with the largest PDP peak value is located as the standard PDP signal, calculates the similarity between the PDP signals on the remaining antennas and symbols and the standard PDP signal, combines the PDP signals with similarity, and obtains the combined PDP sequence for the antennas and symbols; for the high-speed scenario, specifically, the BS obtains the number of detection windows corresponding to RAPID according to the restricted set resource configuration IE (for example, restrictedSetConfig) in the PRACH configuration information. When restrictedSetConfig is configured as restrictedSetTypeA, it means a high-speed cell using restricted set A, the corresponding number of detection windows is 3, and the corresponding windows are denoted as w_{c}_{ᵥ}, w_{c}_{ᵥ}_{-d}_{ᵤ}, w_{c}_{ᵥ}_{+d}_{ᵤ}, respectively; when restrictedSetConfig is configured as restrictedSetTypeB, it means a high-speed cell using restricted set B, the corresponding number of detection windows is 5, and the corresponding windows are denoted as w_{c}_{ᵥ}, w_{c}_{ᵥ}_{-d}_{ᵤ}, w_{c}_{ᵥ}_{+d}_{ᵤ}, w_{c}_{ᵥ}_{-2*d}_{ᵤ}, w_{c}_{ᵥ}_{+2*d}_{ᵤ}, respectively; among them, the cyclic shift value cᵥ=vN_{CS}, v=0, 1, 2, . . .

$$\frac{{L}_{R A}}{{N}_{CS}} - 1 ,$$

dᵤ is the cyclic shift value corresponding to the Doppler frequency offset defined by 3GPP. When restrictedSetConfig is configured as unrestrictedSet, it means a non-high-speed cell using an unrestricted set, the corresponding number of detection windows is 1, and the corresponding window is recorded as w_{c}_{ᵥ}.

The BS obtains the target window w_{target} corresponding to the i-th RAPID and the corresponding PDP sequence of the preamble P_{i,u}[j] according to the obtained number of detection windows.

If the obtained number of detection windows is 1, the PDP corresponding to the target window w_{target} is as follows, and jump to step 5.

$${P}_{i , u} [ j ] = {\vert {x}_{i , u} [ j ] \vert}^{2} ( j = i * Nsw , … ( i + 1 ) * Nsw - 1 ) , i = 0 , … , ⌊ \frac{{L}_{R A}}{Ncs} ⌋ - 1$$

If the obtained number of detection windows is greater than 1, the BS calculates similarity between multiple detection windows, combines multiple windows with similarity, and obtains a target window w_{target} and a corresponding PDP value P_{i,u}[j];

The calculation of similarity between multiple detection windows may be calculated based on the PDP of the preambles in the multiple detection windows, or may be calculated based on the Complex power delay profile (CDP) of the preambles in the multiple detection windows.

When it is selected to perform similarity calculation on multiple detection windows based on PDP, the detection window with the largest PDP of the preamble among the multiple windows is firstly selected as a standard window or reference window, denoted as w_{standard},

$${w}_{s t a n d a r d} = find ( max ( {P}_{i , u} [ j - {d}_{u} ] , {P}_{i , u} [ j ] , {P}_{i , u} [ j + {d}_{u} ] ) ) ( j = i * Nsw , … ( i + 1 ) * Nsw - 1 )$$

Based on the selected standard window or reference window w_{standard}, the cosine similarity of other windows with the standard window or reference window is calculated. For example, assuming that the i-th window is selected as the standard window, the cosine similarity γ between other windows and the standard window is calculated as:

$$γ = \frac{{\sum }_{i * Nsw}^{( i + 1 ) * Nsw - 1} \vert {P}_{i , u} [ j ] \vert * {\sum }_{( i + k ) * Nsw}^{( i + k + 1 ) * Nsw - 1} \vert {P}_{i + k , u} [ j ] \vert}{\sqrt{{\sum }_{i * Nsw}^{( i + 1 ) * Nsw - 1} {\vert {P}_{i , u} [ j ] \vert}^{2}} \sqrt{{\sum }_{( i + k ) * Nsw}^{( i + k + 1 ) * Nsw - 1} {\vert {P}_{i + k , u} [ j ] \vert}^{2}}}$$

* denotes dot product of vectors.

Based on the results of the cosine similarity calculation, determine whether other windows need to be combined with the standard window. For example, the cosine similarity γ is compared with a predefined threshold T. If the similarity is greater than T, the window is considered to have a high similarity with the standard window or reference window; otherwise, it is considered that the similarity between this window and the standard window or reference window is not high, and the BS selects multiple windows with high similarity for combining. The combining method may be coherent combining based on PDP or combining based on CDP.

For example, PDP-based multi-window combining may be expressed as:

$${P}_{i , u} [ j ] = \vert {x}_{i , u} [ j ] {\vert}^{2} + ( \sum \vert {x}_{i + k , u} [ j ] {\vert}^{2} \vert γ > T )$$

$$( j = i * Nsw , … ( i + 1 ) * N s w - 1 ) , i = 0 , … , ⌊ \frac{{L}_{R A}}{Ncs} ⌋ - 1$$

When it is selected to perform similarity calculation on multiple detection windows based on CDP, similarly, first select the window where the maximum PDP value is located among the multiple detection windows as the standard window or reference window, denoted as w_{target},

$${w}_{target} = find ( max ( {P}_{i , u} [ j - {d}_{u} ] , {P}_{i , u} [ j ] , {P}_{i , u} [ j + {d}_{u} ] ) ) ( j = i * Nsw , … ( i + 1 ) * Nsw - 1 )$$

Based on the selected standard window or reference window, the cosine similarity of other windows with the standard window or reference window is calculated. For example, assuming that the i-th window is selected as the standard window, the cosine similarity γ between other windows and the standard window γ is calculated as

$$γ = \frac{{\sum }_{i * Nsw}^{( i + 1 ) * Nsw - 1} Re ( {x}_{i , u} [ j ] ) * {\sum }_{( i + k ) * Nsw}^{( i + k + 1 ) * Nsw - 1} Re ( {x}_{i , u} [ j ] )}{\sqrt{{\sum }_{i * N s w}^{( i + 1 ) * Nsw - 1} \vert {P}_{i , u} [ j ] {\vert}^{2}} \sqrt{{\sum }_{( i + k ) * Nsw}^{( i + k + 1 ) * Nsw - 1} \vert {P}_{i + k , u} [ j ] {\vert}^{2}}} + \frac{{\sum }_{i * Nsw}^{( i + 1 ) * Nsw - 1} Im ( {x}_{i , u} [ j ] ) * {\sum }_{( i + k ) * Nsw}^{( i + k + 1 ) * Nsw - 1} Im ( {x}_{i + k , u} [ j ] )}{\sqrt{{\sum }_{i * Nsw}^{( i + 1 ) * Nsw - 1} \vert {P}_{i , u} [ j ] {\vert}^{2}} \sqrt{{\sum }_{( i + k ) * Nsw}^{( i + k + 1 ) * Nsw - 1} \vert {P}_{i + k , u} [ j ] {\vert}^{2}}}$$

* denotes dot product of vectors, Re denotes the real part of a complex number, Im denotes the imaginary part of a complex number.

Based on the results of calculation of the cosine similarity, determine whether other windows need to be combined with the standard window. For example, the cosine similarity γ is compared with a predefined threshold T. If the similarity is greater than T, the window is considered to have a high similarity with the standard window or reference window; otherwise, it is considered that the similarity between this window and the standard window or reference window is not high, and the BS selects multiple windows with high similarity for combining. The combining method may be coherent combining based on PDP or combining based on CDP.

The window obtained after combining is referred to as the target window and is denoted as w_{target}.
Step 5: Based on the obtained target detection window, the BS performs a preprocessing operation and a candidate user signal cluster identification operation on the obtained target window corresponding to each RAPID, and obtains the time distribution characteristics of the channel and candidate user signal clusters in the target window corresponding to each RAPID, to identify multiple conflicting UEs corresponding to the same RAPID that might be present in the target window, the preprocessing operation includes the following multiple stages or modes or operations, the candidate user signal cluster represents a time window where a UE might present, and the number of candidate user signal clusters represents the possible UE number.
Step 5.1: Data preprocessing operation, the main purpose of this operation is to determine candidate user signal clusters, obtain the separation point between the signal and noise for each user signal cluster (for example, the PDP or CDP corresponding to the separation point may be referred to as a first PDP signal), and calculate the noise power based on the result of the separation point.

First, a sorting operation is performed on the PDP signals of the preamble signals in the target window w_{target} corresponding to each RAPID. The sorting operation may be sorting in descending order according to the peak values of the PDP signals in the window, or sorting in ascending order according to the peak values of the PDP signals in the window. For example, the PDP signals P_{i,u}[j] in the target detection window corresponding to the i-th RAPID are sorted in descending order to obtain the PDP signals \tilde{P}_{i,u}[k] sorted in descending order, where k=f(j),j=i*N_{SW}, . . . (i+1)*N_{SW}−1, k represents the index corresponding to the PDP signals sorted in descending order, j is the index corresponding to the PDP signals before sorting, and f(·) is the mapping function from the corresponding index before sorting to the index after sorting.

Next, based on the sorted PDP signals \tilde{P}_{i,u}[k], determining a separation point between the signal and noise. For example, the separation point between the signal and noise may be obtained by performing an N_order order differential operation on the sorted PDP signal \tilde{P}_{i,u}[k]. For example, the corresponding sequence ∇_{N_order}\tilde{P}_{i,u}[k] after the corresponding N_order order difference may be obtained, and the separation point between the signal and noise may be determined by judging the result of the N_order order difference. The N_order may be configured as 1 or 2 and/or a number greater than 2. For example, for the case of N_order=1, the sequence after the first-order differential calculation ∇₁\tilde{P}_{i,u}[k] may be expressed as:

$${∇}_{1} {\tilde{P}}_{i , u} [ k ] = {\tilde{P}}_{i , u} [ k + 1 ] - {\tilde{P}}_{i , u} [ k ] ( k = 0 , … , Nsw - N\_order - 1 )$$

For the case of N_order=2, the sequence after 2nd-order differential calculation ∇₂\tilde{P}_{i,u}[k] may be expressed as:

$${∇}_{2} {\tilde{P}}_{i , u} [ k ] = {∇}_{1} {\tilde{P}}_{i , u} [ k + 1 ] - {∇}_{1} {\tilde{P}}_{i , u} [ k ] ( k = 0 , … , Nsw - N\_order - 1 )$$

The separation point between the signal and noise may be determined by comparing the above-mentioned sequence of the N_order order difference with a predefined threshold,
for sorting in descending order, find the first index \tilde{k} in the N_order difference sequence where the element value is less than the threshold Tₜₕ, and take this index \tilde{k} as the separation point between the signal and noise:

$$\tilde{k} = find ( {∇}_{N} {\tilde{P}}_{i , u} [ k ] < {T}_{th} ) ( k = 0 , … , Nsw - N\_order - 1 )$$

for sorting in ascending order, find the first index \tilde{k} in the N_order difference sequence where the element value is larger than the threshold Tₜₕ, and take this index \tilde{k} as the separation point between the signal and noise:

$$\tilde{k} = find ( {∇}_{N} {\tilde{P}}_{i , u} [ k ] > {T}_{th} ) ( k = 0 , … , Nsw - N\_order - 1 )$$

The separation point between the signal and noise may also be determined by comparing the sequence after the moving average results of the N-order difference with a predefined threshold,
for sorting in descending order, find the first index \tilde{k} in the sequence after moving average of N-order difference where the element value is less than the threshold Tₜₕ, and take this index \tilde{k} as the separation point between the signal and noise, where:

$$\tilde{k} = find ( {∇}_{MA} {\tilde{P}}_{i , u} [ k ] < {T}_{th} ) ( k = 0 , … , Nsw - L )$$

for sorting in ascending order, find the first index \tilde{k} in the sequence after moving average of N-order difference where the element value is larger than the threshold Tₜₕ, and take this index \tilde{k} as the separation point between the signal and noise, where:

$$\tilde{k} = find ( {∇}_{MA} {\tilde{P}}_{i , u} [ k ] > {T}_{th} ) ( k = 0 , … , Nsw - L )$$

The sequence after result of moving average of N-order difference may be expressed as

$${∇}_{M A} {\tilde{P}}_{i , u} [ k ] = {\sum }_{i = k}^{i = ( k + L ) - 1} {∇}_{N} {\tilde{P}}_{i , u} [ i ] / L$$

$$( i = 0 , … , Nsw - L )$$

Where L is a predefined length of moving average.

In addition, the corresponding noise power may be calculated based on the obtained separation point of signal and noise,
for sorting in descending order, the calculation of the noise power may be expressed as:

$${δ}^{2} = \frac{1}{Nsw - \overline{k}} {\sum }_{i = \tilde{k}}^{Nsw - 1} {∇}_{N} {\tilde{P}}_{i , u} [ i ]$$

for sorting in ascending order, the calculation of the noise power may be expressed as:

$${δ}^{2} = \frac{1}{\tilde{k} + 1} {\sum }_{i = 0}^{\tilde{k}} {∇}_{N} {\tilde{P}}_{i , u} [ i ]$$

Step 5.2: Based on the PDP value of the preamble in the target window corresponding to each RAPID and the corresponding index, obtain the candidate user signal clusters in the target window corresponding to each RAPID. The method for obtaining candidate user signal clusters comprises the following stages or modes or operations;

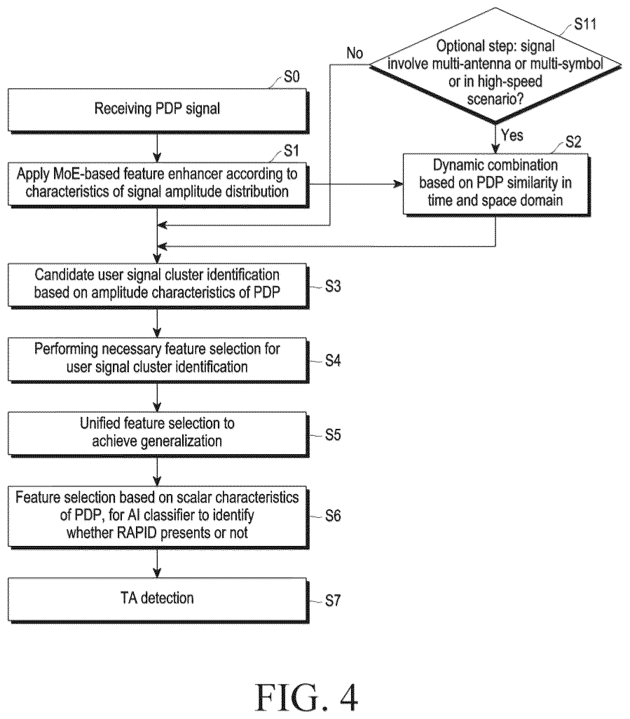

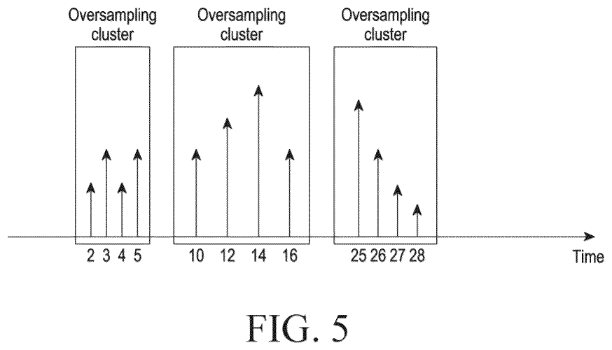

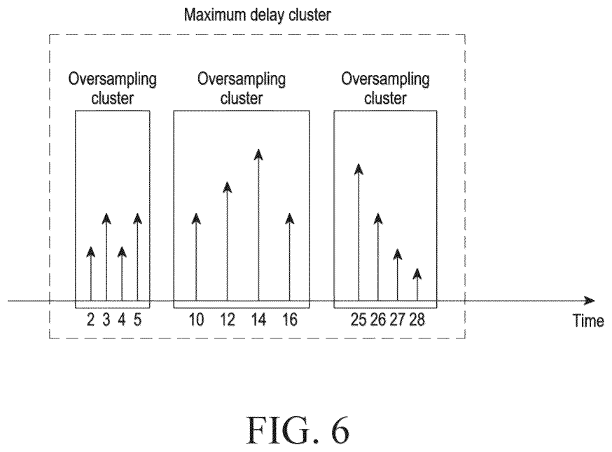

First, the index \tilde{j} of the user signal clusters within the target detection window are obtained based on the determined separation point of signal and noise \tilde{k}, where \tilde{j}=f⁻¹(k), k=0, . . . , \tilde{j}. f⁻¹(·) is the corresponding mapping function from index after sorting to index before sorting. Among the obtained indexes \tilde{j} of the user signal clusters, the user signal clusters with an interval less than Nfft/Lra are combined into one FFT cluster (such as an oversampling cluster), see FIG. 5. Find the time point where the cluster with the largest PDP peak value is located among all FFT clusters as the center cluster, and take the maximum delay spread on both sides as the interval to obtain the maximum delay spread cluster, see FIG. 6; within the maximum delay spread cluster, if the PDP peak values of signals arriving later than the central cluster does not follow an exponential decay, the cluster in which these PDP peak values are located is considered to be a separate user signal cluster, see FIG. 7.

The above method of obtaining candidate user signal clusters may be combined with the distribution of UEs in the cell, may also be combined with preamble resources used for random access, may also be combined with scheduling and processing capabilities of BS. For example, the judgment may be made based on the index \tilde{j} of the valid signal of adjacent user signal clusters. For example, if the distance between the index \tilde{j}ᵢ of the valid signal corresponding to the i-th user signal cluster and the index \tilde{j}ᵢ₊₁ of the valid signal corresponding to the (i+1)-th user signal cluster is less than the predefined threshold T, that is, |\tilde{j}ᵢ₊₁−\tilde{j}ᵢ|<T, it may be considered that adjacent user signal clusters correspond to the same UE.
Step 6: Perform feature screening and/or feature reconstruction operations based on the identified user signal clusters corresponding to each RAPID, and the PDP sequence based on feature screening and/or feature reconstruction is used as input of the subsequent artificial intelligence or deep learning model to perform inference to determine whether a UE is detected for the user signal cluster, and obtain at least one of the UE number, the corresponding RAPID and TA estimate. The operation of the feature screening is to extract \tilde{L}(1≤\tilde{L}<L) consecutive PDP signals within a user signal cluster, where \tilde{L} is a predefined value or a preconfigured value. For example, \tilde{L} may be set according to the tolerance of TA detection error delta_{TA} for feature screening. For example, with tₛₜₐᵣₜ in each user signal cluster as the start point, extract delta_{TA} consecutive PDP signals \tilde{S}_{i,k,u} as PDP signals after feature screening for input to artificial intelligence and/or deep learning models:

$${\tilde{S}}_{i , k , u} = {P}_{i , k , u} [ {t}_{start} ] , {P}_{i , k , u} [ {t}_{start} + 1 ] … , {P}_{i , k , u} [ {t}_{start} + {delta}_{T A} ]$$

It is also possible to extract valid L consecutive PDP signals as PDP signals \tilde{S}_{i,k,u} after feature screening for input to artificial intelligence and/or models based on tₛₜₐᵣₜ in each user signal cluster as the center point:

$${\tilde{S}}_{i , k , u} = [ {P}_{i , k , u} [ {t}_{start} - \frac{{delta}_{TA}}{2} ] , {P}_{i , k , u} [ {t}_{start} + 1 ] … , {P}_{i , k , u} [ {t}_{start} - \frac{{delta}_{TA}}{2} - 1 ] ]$$

The operation of feature reconstruction is to construct other useful features based on the PDP signals after feature screening to characterize the characteristics of the signals. For example, it may be constructed based on the peak average power ratio (PAPR) of the PDP signals after feature screening, it may also be constructed based on the variance of the PDP signals after feature screening. For example, PAPR-based feature construction may be expressed as:

$${\tilde{S}}_{i , k , u} = [ {P}_{i , k , u} [ {t}_{start} - \frac{{delta}_{T A}}{2} ] , {P}_{i , k , u} [ {t}_{start} + 1 ] … , {jP}_{i , k , u} [ {t}_{start} + \frac{{delta}_{T A}}{2} - 1 ] , PAPR ] PAPR = \frac{max ( {P}_{i , k , u} [ j ] )}{average ( {P}_{i , k , u} [ j ] )} , 0 \leq j < L - 1$$

Step 7: The base station performs detection of RAPID and TA estimate based on the PDP sequence after feature screening and feature reconstruction as input to the AI/ML model. In an implementation, in order to further improve the reliability of the detection results, the estimated signal-to-noise ratio SNR may also be used as the input of the model. The signal-to-noise ratio SNR may be used to improve the confidence of the activation decision function. For example, when the model uses sigmoid decision output, based on the estimated signal-to-noise ratio SNR, the corresponding activation decision function may be modified as:

$$E\_g ( z ) = min ( max ( \frac{1}{1 + {e}^{- z}} * ( 1 - \frac{Noise}{max\_peak} ) , 0 ) , 1 )$$

where the estimated SNR is denoted as

$$\frac{max\_peak}{Noise} .$$

If the estimated SNR is larger, the detection result is more reliable; on the contrary, if the estimated SNR is smaller, the reliability of the detection result is smaller.

Confidence calibration is performed based on the input of AI/ML model. For example, when the output result E_g(z) is less than the predefined value X, it means that no UE has been detected in the detection window; otherwise, when it is greater than the predefined value X, it means that a UE has been detected in the detection window, and the predefined value X may be set to 0.5.

This application does not have any restrictions on the selected AI/ML model. It may be a multi-layer perceptron (MLP), a convolutional neural network (CNN), a residual neural network (ResNet) or a kernel machine, or other models.

Through the method provided in this example aspect, with the MoE-based feature enhancer, not only the false alarm problem caused by too strong noise under low signal-to-noise ratio may be avoided, but also the miss detection problem under weak amplitude of the signal may be avoided, thereby improving the overall detection performance.

Through the method provided in this example aspect, the method of adaptive combining multiple detection windows for HST for multi-antenna, multi-symbol, and/or high-speed scenarios may not only avoid the problem of miss detection due to power dispersion under the Doppler effect, but also avoid false alarm problems caused by multi-window combining in noisy environments and improve overall detection performance.

Through the method provided in this example aspect, by obtaining candidate user signal clusters, it is possible to predict the possible UE number corresponding to the same preamble ID. In an implementation, further, through the extraction of channel features, multipath components and different UE signals may be distinguished, thereby improving the accuracy of detected information corresponding to multiple UEs for the same preamble ID. In addition, in an implementation, through screening and reconstruction of features, the complexity of the AI/ML model may be further reduced, and at the same time, the generalization of the AI/ML model may also be improved.

In addition, through the method provided in this example aspect, by adopting the method for the measure of multi-window similarity and the detection of candidate user signal clusters, the detection performance of multiple UEs under conflicts may be improved. Compared with single-UE transmission and detection, the preamble resource overhead for random access by UEs may be saved, and may increase the possibility of subsequent cancellation of the PRACH transmission resource restricted set, thereby further saving resources.

Furthermore, through the method provided in this example aspect, the path with the strongest signal PDP selected among the signals in each candidate user signal cluster may be used as the TA of the UE to improve the accuracy of TA estimation. In an implementation, based on the original sigmoid activation function, by designing a confidence level based on SNR, the robustness of detection may be improved.

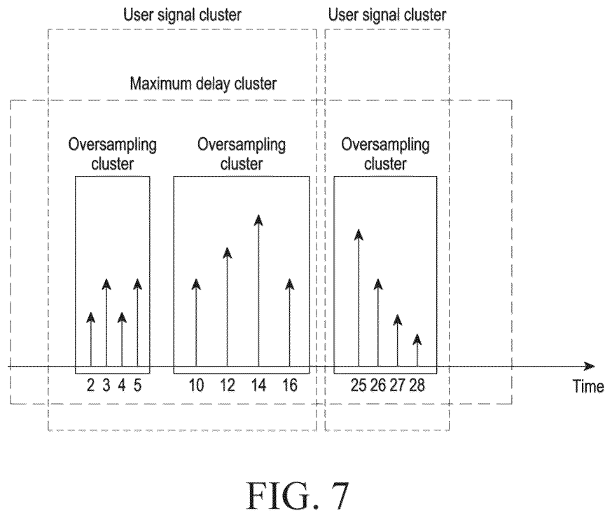

An example flowchart in a multi-UE access scenario according to an embodiment of the present disclosure will be described below. FIG. 8 illustrates an example flowchart for contention-based access in a multi-UE scenario according to embodiments of the present disclosure.

As shown in FIG. 8, a plurality of UEs (e.g., the first number of UEs, shown as two UEs in FIG. 8) transmit a random access preamble (msgl) to a base station (e.g., gNB). For example, two UEs randomly select a preamble from 64 preamble resources and select the same preamble (e.g., corresponding to the same random access signal), use the selected preamble to transmit their MSG1 on PRACH.

When receiving MSG1, the base station uses a detection algorithm to detect multiple users. In this case, there will be two UEs with the same random access preamble identification information (e.g. RAPID). The base station may employ an AI-based PRACH receiver to efficiently detect multiple users based on the PDP amplitude characteristics.

Next, the BS transmits a response message to the same preamble. For example, the BS indicates the scheduling information of MSG2 physical downlinked shared channel (PDSCH) RAR through MSG2 PDCCH. Within an RAR window, the UE monitors PDCCH to receive PDSCH RAR.

In addition, the BS performs RAR transmission. For example, RAR contains RAPID, T-CRNTI, TA, UL grant, UE number indication information for uplink synchronization of UE and subsequent MSG3 transmission. For example, the TA included in the RAR may be absolute TA values, or may be first TA information and second TA information, such as a reference TA and a relative TA, where the reference TA is the TA value of one of the UEs, and the TA value of the other UE may be obtained by the reference TA and the relative TA.

For example, the BS may transmit a RAR to each UE to be accessed, and the RAR includes: the TA of at least one UE (for example, a second number of UEs) requesting random access, TA obtaining indication information (for example, referred to as TA flag, or referred to as indication information of TA-related information, indicating the UE to obtain corresponding TA-related information) and uplink transmission resource information (or resource allocation information for the second number of UEs).

For example, the TA-related information includes at least one of: downlink pathloss between the UE and the base station; a receiving time and a transmitting time of a system information block SIB1; signal strength related information and threshold information. For example, the TA flag indicates the method used by the UE to obtain its TA or TA estimate value, and may indicate, for example, one of the following three methods: a threshold-based method, a SIB1 receiving time-based method, or a pathloss-based method.

For example, the BS may include demodulation reference signal (DMRS)-related information in the RAR to indicate overlapping UL grants through space division multiplexed DMRS.

For example, the T-CRNTI, DMRS, and UL grant of the UE may be mapped by the TA pattern of the UE:

$${DMRS}_{UE} = {DMRS}_{TA\_index}$$

$${TCRNTI}_{UE} = {TCRNTI\_reference}_{UE} + {TCRNTI}_{offset}$$

where,
TA_index is the index of the TA obtained by the UE in the RAR in the corresponding TAC field of the RAR;
The DMRS corresponding to the TA index indicates the port where the base station receives the UL grant;
TCRNTI_{offset} is the offset between the TA index of the UE and the TA index of the reference UE, that is,

$${TCRNTI}_{offset} = {TA}_{{index}_{UE}} - {TA}_{{index}_{{reference}_{UE}}}$$

For example, the number of UEs (for example, the second number) indicated by the UE number indication information may represent the length of the RAR.

During the random access response (RAR) window, the base station transmits message 2 (msg2) to these UEs, for example, the PDCCH of message 2 (e.g., including DCI 1_0) and the PDSCH of message 2, the PDSCH includes the random access response (RAR). With message 2, the base station may transmit information for uplink transmission (e.g., first information related to UE access) to multiple UEs, for example, including at least one of: preamble identification information (e.g., RAPID), UE number, DMRS resources, timing advance (TA) related information (e.g., absolute TA values, or reference TA value and/or relative TA values or TA offset values), TA obtaining indication information (e.g., shown as TA flag in the figure), uplink grant (UL grant), temporary cell radio network temporary identifier (T-CRNTI), etc. In some implementations, the above information for uplink transmission may also include threshold-related information, for example, an RSRP threshold used by the UE to determine the TA estimate value (for example, referred to as first threshold information), or may also include threshold offset information, such as RSRP threshold offset (or referred to as threshold-related step size). The above information for uplink transmission may be transmitted to multiple UEs through PDCCH and PDSCH, or may be transmitted to multiple UEs through PDSCH. For example, a part (for example, a first part) of the above-mentioned information for uplink transmission may be carried in the PDCCH through DCI, and another part (for example, a second part) of the above-mentioned information for uplink transmission may be carried in the PDSCH through the MAC PDU. Alternatively, all of the above information for uplink transmission may be carried in the PDSCH through the MAC PDU. In some implementations, for example, the first part may include at least one of: RAPID, UE number, TA obtaining indication information, reference TA, and RSRP threshold, and the second part may include the remaining information among the above information for uplink transmission. The RSRP threshold is only an example of threshold related information, other thresholds may also be used, for example thresholds related to radio conditions or signal reception situations, such as an RSRQ threshold, an RSSI threshold, SINR, SNR, etc.

Within the RAR window, the UE receives RAR reception. For example, after the UE receives MSG2, the UE decodes RAR and obtains its parameters for MSG3 transmission. For example, the UE obtains its TA based on the TA obtaining indication information (such as TA flag), and obtains its DMRS and T-CRNTI based on the obtained TA.

After receiving the RAR, the UE may perform scheduled uplink transmission (e.g. MSG3 PUSCH) according to the information in the RAR.

For example, the UE transmits MSG3 which carries the identity of the UE, at the corresponding DMRS port according to TA, UL Grant, and T-CRNTI. For example, the corresponding DMRS port is the port corresponding to the DMRS obtained by the UE based on the obtained TA.

After receiving the physical uplink shared channel (PUSCH) transmission, the base station may transmit PDSCH (MSG4) including contention resolution information related to multiple UEs during a contention resolution (CR) timer. For example, the BS decodes each MSG3 at each DMRS port to obtain the identifier of each UE.

In addition, the BS transmits a message 4 (MSG4) to each UE, which carries the identifier of the UE.

The UE monitors MSG4 during the CR timer and checks whether the identifier carried in MSG4 is the same as the identifier transmitted by the UE in MSG3, and if the same, the access is considered successful.

It should be understood that for convenience of expression, in this disclosure, sometimes the RAR of message 2 is not strictly distinguished from physical downlink control channel (PDCCH) or download control information (DCI) 1_0. In such a case, the RAR mentioned may be understood as message 2, including PDCCH and PDSCH. For example, the above-mentioned “after receiving RAR” may refer to after receiving message 2, and the above-mentioned “according to the information in RAR” may refer to according to the information in message 2, including information in DCI 1_0 in the PDCCH and information in RAR included in PDSCH.

In some implementations, the MSG2 may include TA obtaining indication information or a field related to the TA obtaining indication information (for example, a TA flag field), and the TA obtaining indication information may be used to indicate to the UE on which method to obtain the TA estimation value, such as indicating one of a threshold-based method, a SIB1 receiving time-based method, and a pathloss-based method. Example methods for obtaining TA estimate values based on various methods will be described in detail below.

In some implementations, MSG2 may not include TA obtaining indication information, or may not include the field related to TA obtaining indication information, and the UE may use a threshold-based method to obtain the TA estimate value by default. For example, in some implementations, threshold related information may be included in MSG2, and the UE may obtain the TA estimate value based on the threshold related information. Alternatively, MSG2 may also include threshold offset information, or referred to as information related to threshold stepsize, and the UE may obtain the TA estimate value based on the threshold related information and the threshold offset information.

In some implementations, at least one of the following may be included in the DCI of MSG2: RAPID, UE number, TA obtaining indication information, reference TA, RSRP threshold. In this way, the UE may acquire information related to uplink transmission faster, or the decoding or detection complexity of the UE may be reduced.

Through the above method, the base station may resolve multi-UE access conflicts through message 2 to a certain extent and enable multiple UEs to access the system faster. The above method may reduce access delay.

The methods of the present disclosure will be described in more detail below in conjunction with several example aspects.

### Example Aspect Two

In this example aspect, the method for the BS side to transmit the random access response MSG2 RAR in a multi-UE scenario according to one or more embodiments will be introduced.

After the BS receives the MSG1, the BS detects the preamble according to the AI-based PRACH detection method in the multi-UE scenario in the above example aspect one, and obtains the information of the PUSCH transmission scheduled by the RAR (for example, the first information related to UE access), the information includes RAPID, the UE number for the same RAPID, optional DMRS resource indication, TA, TA obtaining indication information (for example, expressed as TA flag), T-CRNTI, UL Grant resource, etc., the information is transmitted to UEs in the MAC RAR PDU. In an implementation, the above information of PUSCH transmission is transmitted to the UEs through message 2 (Msg2), and the Msg2 may include PDCCH and PDSCH RAR, and the information of PUSCH transmission may be transmitted to the UE through the PDCCH and/or PDSCH RAR of Msg2.

The MAC RAR PDU consists of one or more RAR subPDUs, one or more multi RAR subPDUs and optional padding.

When the BS detects random access requests from multiple UEs on the same PRACH or PRACH occasion (RO) resource, that is, the RA-RNTIs of these UEs are the same, but each UE has a different RAPID, one or more RAR subPDUs are used to respond to these access requests.

When the BS detects random access requests from multiple UEs on the same PRACH or PRACH occasion (RO) resource, that is, the RA-RNTIs of these UEs are the same, but each UE has the same RAPID, one or more multi RAR subPDUs are used to respond to these access requests. For example, the multi RAR subPDU may include information related to uplink transmission of multiple UEs with the same RAPID, and the payload length of the multi RAR subPDU may be extended relative to the payload of the RAR subPDU, or a multi RAR subPDU may be regarded as multiple RAR subPDUs.

Among them, the RA-RNTI is obtained by the BS in decoding the preamble, for subsequently scrambling the MSG2 DCI format 1_0 with the RA-RNTI, and is transmitted through the PDCCH.

$$R A - RNTI = 1 + {s}_{-} i d + 14 \times t\_id + 14 \times 80 \times f\_id + 14 \times 80 \times 8 \times ul\_carrier \_id$$

The location for carrying the information of the PUSCH transmission may be carried through PDCCH DCI 1_0 and PDSCH RAR together. For example, the first part of the information of the PUSCH transmission is carried in DCI 1_0, and the second part of the information of the PUSCH transmission is carried in PDSCH.

For the same RAPID with N>1 UEs (e.g., a second number of UEs), that is, the UE number for the same RAPID is N (e.g., the second number):

### Form 1

RAPID is carried in a field in DCI 1_0:

Assuming that the number of RAPIDs with N UEs is M, the RAPIDs are carried with 6 Mbits in the Reserved field of DCI 1_0.

Other information is carried in the subheader or payload of PDSCH RAR. The other information includes the UE number N (or referred to as first UE number information) for the same RAPID (for example, referred to as a first RAPID or first preamble identification information), TA, and TA obtaining indication information (for example, information indicating that the UE should obtain corresponding TA-related information), T-CRNTI, UL Grant resource and/or DMRS resource indication. For example, the TA-related information includes at least one of: downlink pathloss between the UE and the base station; a receiving time and a transmitting time of a system information block SIB1; signal strength related information and threshold information.
Wherein,
The UE number N for the same RAPID is indicated in the UE information field in the RAR subheader, occupying log₂ N bits.
If DMRS resource information is present, it may also be indicated in the UE information field in the RAR subheader, placed after the UE number information, and occupied N*log₂N bits.
if DMRS resource information is present, the UE information field occupies a total of ceil((N*log₂ N+log₂ N)/8) bytes. When it is less than a full byte, the beginning ceil((N*log₂ N+log₂ N)/8)*8−N*log₂ N−log₂ N bits of the field is used as the Reserved field.
When DMRS resource information is not present, the UE information field occupies a total of ceil(log₂ N/8) bytes. When it is less than a full byte, the beginning ceil(log₂ N/8)*8−log₂ N bits of the field is used as the Reserved field.

In an implementation, the TA obtaining indication information among the other information is carried in a field of the RAR payload (for example, the TA Flag field). It should be understood that the field name TA Flag used in this disclosure is only an example, and other names may also be used.

The TA obtaining indication information is used to indicate the method used by the UE to obtain the TA, for example, occupying 2 bits.
When TA Flag=0 or no TA Flag is configured, the UE is indicated to obtain TA in a threshold-based manner; wherein, the absolute threshold part (for example, referred to as first threshold information) is carried in DCI1_0, occupying 7 bits, for example; the relative threshold (for example, referred to as threshold offset information) is carried in a field of the RAR payload (for example, the RSRP_offset field), for example, occupying 1 bit. It should be understood that the field name RSRP_offset used in this disclosure is only an example, and other names may also be used.
When TA Flag=1, the UE is indicated to obtain the TA based on the free space fading model. For example, the UE may obtain the TA estimate value based on the pathloss value, and then obtain the TA value for the UE based on the TA estimate value and according to the TA-related information in DCI and/or RAR;
When TA Flag=2, the UE is indicated to use the receiving time of SIB1 to obtain the TA; the transmitting time of SIB1 is carried in SIB1. For example, the UE may obtain the TA estimate value based on the receiving time and transmitting time of SIB1, and then obtain the TA value for the UE based on the TA estimate value and according to the TA-related information in DCI and/or RAR.

In an implementation, the RAR may not include TA obtaining indication information or the TA Flag field. In this case, the UE obtains the TA by way of determining the TA estimate value based on the threshold by default.

The TA among the information is carried in the TAC field of the RAR payload:
It may be absolute TA values for each UE, arranged from small to large, occupying 12N bits.
It may also be a reference TA value TA_baseline (or it may also be referred to as a second TA, a reference TA or a standard TA, etc., or it may also be expressed as a reference TA or TA_{reference}) and N−1 relative TA values delta_TA (or also be referred to as difference TAs, TA differences, etc.) relative to the reference TA, occupying 12+(N−1)*8 bits.

The reference TA is selected as the minimum value of TAs for UEs with the same RAPID,

$$delta\_TA = ( TA - TA\_baseline ) / unit\_TA$$

where, unit_{TA} is the minimum time granularity at which the BS side algorithm may identify N UEs. For example, the predefined maximum delay spread Max_dalay_spread_sample may be selected as the minimum time granularity for distinguishing between N UEs:

$$unit\_TA = Max\_dalay \_spread {\_sample}^{*} 16 / ( 15 {K}^{*} 2048 )$$

The UL Grant among the information is carried in the UL Grant field of the RAR payload:
The same PUSCH time-frequency domain resources may be allocated to N UEs, occupying a total of 27 bits.

Orthogonal PUSCH time-frequency domain resources may be allocated to N UEs, each UE occupies 27 bits, occupying a total of N*27 bits.

The T-CRNTI among the information is carried in the T-CRNTI field of the RAR payload:
Random T-CRNTI sequences are allocated to N UEs, occupying N*16 bits.

### Form 2

The RAPID and UE number N are carried in the DCI1_0 field:
Assuming that the number of RAPIDs with multiple UEs is M, the RAPIDs are carried in 6 Mbits in the Reserved field of DCI1_0; the UE numbers are carried in 6 Mbits, and occupying a total of M*12 bits.

Other information is carried in the subheader or payload of PDSCH RAR. The other information includes TA, T-CRNTI, UL Grant resource and optional DMRS resource indication for the same RAPID.

If DMRS resource information is present, it may be indicated in the UE information field in the RAR subheader, occupying N*log₂N bits, occupying ceil(N*log₂ N/8) bytes in total. When it is less than a full byte, the beginning ceil(N*log₂ N/8)*8−N*log₂ N bit of the field is used as the Reserved field.

Other information is carried in the same manner as described in the first form, and the other information includes TA, TA obtaining indication information, T-CRNTI, and UL Grant resources for the same RAPID.

### Form 3

RAPID, UE number and reference TA are carried in the DCI1_0 field: Assuming that the number of RAPIDs with N UEs is M, the RAPIDs are carried in 6 Mbits in the Reserved field of DCI1_0; the UE numbers are carried in 6 Mbits; the reference TA occupies 12 Mbits, occupying a total of 24M bits.

Other information is carried in the subheader or payload of PDSCH RAR. The other information includes TA, TA obtaining indication information, T-CRNTI, UL Grant resource and optional DMRS resource indication for the same RAPID.

Wherein, the TA information of N−1 UEs is carried in the TAC field of the PDSCH payload:
It may be absolute TA values, arranged in a first order, such as from small to large, occupying 12*(N−1)bits.
It may be relative TA values delta_TA relative to the reference TA, occupying 8*(N−1) bits.

The method for carrying the optional DMRS resource information is the same as that described in the second form.

Other information is carried in the same manner as described in the first form, and the other information includes T-CRNTI, TA obtaining indication information, and UL Grant resources.

The information of PUSCH transmission may only be carried in the subheader and payload of the PDSCH RAR.

The information of UE number N is indicated in the UE information field in the RAR subheader and occupies log₂ N bits.

If DMRS resource information is present, it may also be indicated in the UE information field in the RAR subheader, placed after the UE number information, and occupying N*log₂N bits.

If DMRS resource information is present, the UE information field occupies a total of ceil((N*log₂ N+log₂ N)/8) bytes. When it is less than a full byte, the beginning ceil((N*log₂ N+log₂ N)/8)*8−N*log₂ N−log₂ N bits of the field is used as the Reserved field.

If DMRS resource information is present, the UE information field occupies a total of ceil(log₂ N/8) bytes. When it is less than a full byte, the beginning ceil(log₂ N/8)*8−log₂ N bits of the field are used as the Reserved field.

Other information is carried in the PDSCH RAR payload, and the other information includes TA, T-CRNTI, UL Grant resources, and the carrying form is the same as the first form of carrying jointly by PDCCH DCI1_0 and PDSCH RAR.

The location of carrying information of PUSCH transmission may be carried only in the PDSCH RAR.

Wherein, the UE number and optional DMRS resource are carried in the UE information subheader in the PDSCH RAR subheader. Wherein, the UE number occupies log₂ N bits, the optional DMRS resource indication occupies N*log₂N bits, and the bits that do not full integer bytes are set to reserved at the beginning of the subheader.

Other information is carried in the PDSCH RAR payload.

Wherein, the TA information is in the TAC field. If it is an absolute TA value, it occupies 12N bits; if it is reference TA and relative TA, occupy 12+(N−1)*8 bits.

UL Grant is in the UL Grant field, if orthogonal PUSCH resources are allocated, it occupies N*27 bits; if the same set of PUSCH resources is allocated, it occupies 27 bits.

T-CRNTI is in the T-CRNTI field and occupies N*16 bits.

For PDSCH RAR payload that does not occupy and full an integer of bytes, the beginning of the payload area is set to be Reserved.

The method provided in this example aspect realizes the feedback of multi-UE information by designing the way in which multi-UE detection information is carried in the random access response, which is the basic guarantee for simultaneous access by conflicting UEs in a multi-UE scenario.

The method provided by this example aspect improves latency by carrying the RAPID, and/or the UE number, and/or the reference TA in the PDCCH, so that the UE may start TA estimation or acquisition before decoding the PDSCH.

The method provided in this example aspect indicates the method for the UE to obtain the TA through the TA obtaining indication information, so that the UE may obtain the TA more accurately.

The method provided by this example aspect saves resource overhead in the form of indicating TA by the reference TA and the relative TA jointly.

The method provided in this example speeds up the time for the UE searching and selecting the TA and reduces UE power consumption by arranging TAs into the TAC field from small to large.

The method provided in this example provides a method for obtaining T-CRNTI, and/or UL Grant, and/or DMRS based on TA index, which speeds up the time for the UE to obtain information and reduces UE power consumption.

In the method provided in this example aspect, the UL Grant for multiple UEs may share one set of time-frequency domain resources, and UEs may be distinguished through orthogonal DMRS resources or randomization of T-CRNTI, thereby saving uplink resources.

### Example Aspect Three

In this example aspect, the method for the UE side to receive the random access response RAR in a multi-UE scenario according to the present embodiment will be introduced.

After the UE transmits the preamble (for example, corresponding to first preamble identification information), the UE may receive message 2 (Msg2). For example, the description in above Example Aspect Two may be referred to for the information content that may be included in the Msg (such as the above information of the PUSCH transmission), which will not be described again here. The UE shall perform the following steps on Msg2 RAR:
Step 1: Calculate the RA-RNTI associated with the PRACH, and continuously monitor PDCCH within the message waiting window ra-ResponseWindow to receive the RAR. All RARs received by the UE within this window are considered valid; if the UE does not receive an RAR fed back by the BS within the RAR time window, it is considered that this random access procedure has failed, and the UE retransmits MSG1. The RA Response window is obtained through the rar-WindowLength IE of the SIB message; The PDCCH is located in the Type 1 PDCCH Common Search Space (CSS), carries DCI format 10, scrambled with RA-RNTI.
Step 2: After successfully decoding the PDCCH, the UE will obtain the RB resource information of the PDSCH RAR to receive the downlink transport block transmitted through the PDSCH, and/or detection result information. The detection result information includes optional RAPID, optional UE number, optional reference TA, and optional absolute threshold.
Step 3: If the PDCCH carries related detection result information, the UE obtains its own TA (for example, TA estimation information) based on the parsed detection result information. Otherwise, jump to step 4.
   Form 1: For the Case where PDCCH DCI 1_0 Contains Only RAPID

The UE parses the 6M least significant bits in DCI 1_0 and checks whether the RAPID therein is the same as the RAPID of the preamble transmitted by itself. If the same, it means that there are multiple UEs for this RAPID. The UE estimates or obtains its own TA (for example, TA estimation information) according to the configuration method of TA obtaining indication information.

When TA_flag=0 or TA_flag is not configured, a threshold-based method is used for the UE side TA estimation to obtain TA, where the absolute threshold is obtained in DCI1_0 and the relative threshold is obtained in RAR payload. Then the UE obtains the TA through the following method:

$$TA\_est = \{ \{ \begin{matrix}{reference}_{TA} , RSRP > {RSRP}_{threshold} \\ {TA}_{1} , {RSRP}_{threshold} \leq RSRP < {RSRP}_{threshold} - {threshold}_{offset} \\ {TA}_{n} , {RSRP}_{threshold} - ( n - 1 ) * {threshold}_{offset} RSRP \leq {RSRP}_{threshold} - n * {threshold}_{offset ,} n > 1\end{matrix}$$

When TA_flag=1, the UE obtains TA based on the free space fading model: the UE first calculates the downlink (DL) pathloss (PL) PL, and then calculates the distance d between the BS and the UE based on the relationship between free space pathloss and distance, and finally estimates TA based on the relationship between distance and time.

$$\begin{matrix}PL = Prx - Ptx = RSRP\_DL - reference power \\ PL = 20 log ( d ) + 20 log ( f ) - 147.55 \\ TA\_est = 10 \hat{} ( ( PL - 20 log ( f ) + 147.55 ) / 20 ) * ( 15 K * 2048 ) / 16 * 3 * 1 e 8 )\end{matrix}$$

where f is the carrier frequency of the signal, RSRP DL is the power of the reference signal received in downlink measured by the UE side, and reference power is the reference signal power ss-PBCH-BlockPower, carried in the SIB.

When TA_flag=2, the UE obtains TA based on the receiving time of SIB1, where the transmitting time of SIB1 is carried in SIB1:

$$TA\_est = {receiveTime}_{SIB 1} - {transTime}_{SIB 1}$$

Form 2: For the Case where PDCCH DCI 1_0 Contains RAPID and UE Number:

The UE parses the 12M least significant bits in DCI 1_0 and checks whether the RAPID therein is the same as the RAPID transmitted by itself. If they are the same, the UE parses the 6-bit information after RAPID to obtain the UE number to obtain the PDSCH RAR decoding length. After the UE completes parsing the information, it needs to continue to estimate or obtain its own TA.

The method for the UE to estimate or obtain TA is the same as that in Form 1 in this step.

Form 3: For the Case where PDCCH DCI 1_0 Contains RAPID, UE Number and Reference TA:

The UE parses the 24M least significant bits in DCI 1_0 and checks whether the RAPID therein is the same as the RAPID transmitted by itself. If they are the same, the UE parses the 6-bit information after RAPID to obtain the UE number information to obtain the PDSCH RAR decoding length; The UE parses the 12-bit information after the UE number to obtain the minimum reference TA value for this RAPID. After the UE completes parsing the information, it needs to continue to estimate or obtain its own TA.

The method for the UE to estimate or obtain TA is the same as that in Form 1 in this step.

In addition, if the TA values in the PDSCH RAR payload are relative TA values, the UE may continue to estimate its own relative TA value delta_TA.

$$delta\_TA = min ( abs ( delta\_TA \_RAR - ( TA\_UE - TA\_baseline ) / unit\_TA ) )$$

Step 4: UE decodes PDSCH carrying Mgs2 RAR data and selects required information for RAR scheduled PUSCH transmission (e.g., some of the above information of PUSCH transmission).
   Form 1: For the Case where PDCCH DCI1_0 Contains Only RAPID

The required information includes RAPID, the UE number for the same RAPID, and second information related to uplink transmission, such as optional DMRS resource indication, TA, T-CRNTI, and UL Grant resources. In an implementation, the required information also includes the TA obtaining indication information as described above. Based on the TA obtaining indication information, the UE may use a corresponding method to obtain the TA estimate value.

The UE finds the MAC subPDU that is consistent with the transmitted RAPID by decoding the RAPID subheader, then obtains the UE number through the UE information subheader, obtains the PDSCH RAR payload length that needs to be decoded, and decodes the PDSCH RAR payload.

If the TAC field in the PDSCH RAR payload involves absolute TA values, the UE compares its estimated TA with the results of each TA in the RAR payload, and selects the closest absolute TA value as its own TA value final_TA (for example, it may also be referred to as first TA information), and records the index index(delta_TA) of final_TA in the TAC.

$$final\_TA = min ( abs ( TA\_UE - TA\_RAR ) )$$

If the TAC field in the PDSCH RAR payload involves relative TA values delta_TA, the UE compares its estimated TA with the first reference TA in the RAR payload to calculate the relative TA value; then selects the closest relative TA value delta_TA as its own relative TA value; finally, based on the relationship between the relative TA and the absolute TA value, obtains the final TA value final_TA of the UE, and records the index

$$index ( delta\_TA ) of final\_TA in the TAC at the same time .$$

$$delta\_TA = min ( abs ( delta\_TA \_RAR - ( TA\_UE - TA\_baseline ) / unit\_TA ) )$$

$$final\_TA = delta\_TA * unit\_TA + TA\_baseline$$

If DMRS resources is present, the UE selects the DMRS resource with an index index(delta_TA) in the UE in formation subheader.

The UE selects the T-CRNTI corresponding to the index index(delta_TA) in the T-CRNTI field.

The UE selects UL Grant information through the UL Grant field. If there is the same set of UL Grant information in the PDSCH RAR payload, all UEs use the same set of UL Grant resources; if there is orthogonal UL Grant information in the PDSCH RAR payload, the UE selects the UL Grant resource corresponding to the index index(delta_TA).

Form 2: For the Case where PDCCH DCI1_0 Contains RAPID and UE Number

The required information includes optional DMRS resource indication, TA, T-CRNTI, and UL Grant resource. In an implementation, the required information also includes the TA obtaining indication information as described above. Based on the TA obtaining indication information, the UE may use a corresponding method to obtain the TA estimate value.

The UE has obtained the PDSCH RAR length through the PDCCH, and then the UE obtains the above information in different fields of the PDSCH RAR subheader or payload. The method for obtaining is the same as that in Form 1 in this step.

Form 3: For the Case where PDCCH DCI1_0 Contains RAPID, UE Number and Reference TA

The required information includes optional DMRS resource indication, N−1 TAs other than the reference TA, T-CRNTI, and UL Grant resources. In an implementation, the required information also includes the TA obtaining indication information as described above. Based on the TA obtaining indication information, the UE may use a corresponding method to obtain the TA estimate value.

The UE obtains the PDSCH RAR length through the PDCCH and its own relative and/or absolute TA values, and then the UE obtains the above information in different fields of the PDSCH RAR subheader or payload. The method for obtaining is the same as that in Form 1 in this step.

Form 4: Case where Information is all Carried in PDSCH RAR

The information includes RAPID, the UE number for the same RAPID, optional DMRS resource indication, TA, T-CRNTI, and UL Grant resources. In an implementation, the required information also includes the TA obtaining indication information as described above. Based on the TA obtaining indication information, the UE may use a corresponding method to obtain the TA estimate value.

The UE decodes the RAPID in the RAPID subheader and checks whether it is the same as the transmitted RAPID. If it is the same, the UE continues to decode and obtain the required information for RAR scheduling PUSCH. The required information includes the UE number for the same RAPID and optional DMRS resource indication, TA, TA obtaining indication information, T-CRNTI, UL Grant resources; if it is not the same as the transmitted RAPID, it is considered that the present random access procedure has failed, and the UE retransmits MSG1.

The obtaining of other information is the same as that in Form 1 in this step.
Step 5: The UE obtains the RAR scheduled physical uplink shared channel (PUSCH) scheduling information based on the result of decoding response, and transmits the RAR scheduled PUSCH. In an implementation, the UE may obtain the DMRS resource indication corresponding to the UE based on the obtained TA-related information, and may also obtain the uplink resource corresponding to the UE based on the TA-related information or the uplink resources in the RAR may be used for multiple UEs. In an implementation, the DMRS resource indication includes DMRS port information. For example, based on the obtained TA-related information, the UE transmits PUSCH through the DMRS port corresponding to the obtained DMRS resource indication on the uplink resource corresponding to the UE. After transmitting PUSCH, the UE will start the ra-ContentionResolutionTimer timer at the same time. Before the timer expires, the UE will continue monitoring the PDCCH of Msg4. If the timer expires, the UE considers that the contention has failed and re-initiates the random access procedure.

The UE performs TA adjustment according to the obtained TA value, and the UE saves T-CRNTI for decoding the DCI of PUSCH retransmission scheduled by RAR or the DCI of MSG4, and for scrambling processing of PUSCH transmission. The UE determines the PUSCH transmission configuration and time-frequency domain resource information through the UL Grant. For example, the UE may obtain the T-CRNTI corresponding to the UE based on the obtained TA value, and use the T-CRNTI to scramble the uplink transmission.

The method provided in this example aspect designs a method how multiple UEs on the UE side receive RAR, which ensures that each UE correctly obtains its own information and does not interfere with each other. It is the key to ensuring that conflicting UEs access simultaneously.

The method provided in this example aspect provides a feasible method for the UE side to obtain TA, and provides guidance for the UE to select TA.

Example embodiments of the present disclosure will be described in greater detail below in conjunction with several more specific embodiments.

One or more embodiments provide a method for detecting preamble-related information during the random access procedure of the UE performed by the BS based on Artificial Intelligence (AI) in a communication system, and the preamble-related information includes RAPID, TA obtaining indication information, TA, RAR scheduled uplink service channel (physical uplink shared channel, PUSCH) scheduling information. Its process includes the following multiple phases or modes or operations:
Step 1, the UE obtains configuration information for PRACH transmission based on the received System Information Block (SIB1), generates and transmits a preamble with a zero correlation zone of a length N_{cs}−1 generated by cyclic shift. The configuration information for PRACH transmission includes PRACH transmission parameters, restricted set resources, root sequence number, and cyclic shift offset N.
Step 2, the BS obtains the time domain detection signal within N SWs based on the received time domain signal of preambles, for example N=64, its process includes the following multiple phases or modes or operations:
Step 2.1, the BS performs front-end processing on the received time domain signal of preambles, and obtains the frequency domain signal Yₙ of preambles according to the configured frequency domain resource information of preamble signal, wherein the front-end processing includes removing the cyclic prefix (CP) of the preamble sequence, downsampling, and discrete fourier transform (DFT) of L_{RA} points.
Step 2.2, the BS correlates the received preamble sequence Yₙ with the local U pre-generated frequency domain preamble sequences X_{u,n} to obtain a frequency domain correlation sequence Z_{u,n} of a length L_{RA} after correlation. The correlation operation may be expressed as:

$${Z}_{u , n} = {Y}_{n} {X}_{u , n}^{*} , n = 0 , 1 , … , {L}_{R A} - 1 , u = 0 , 1 , 2 , … U$$

where (·)*represents the conjugate operation of complex numbers; L_{RA} may be 139, may be 839, or may be 1157, or other values.
Step 2.3, perform N_{ifft} point inverse fast fourier transform (IFFT) on Z_{u,n} to obtain time domain correlation result x.

$$x ( i ) = IFFT ( {z}_{u , n} ) , i = 0 , 1 , … {N}_{ifft} - 1$$

Step 2.4: Extract the time domain correlation result xₖ of the k-th search window (SW) based on N_{cs} in Step 1, also referred to as CDP (Complex PDP), xₖ is expressed as follows:

$${x}_{k} = x ( k * {N}_{S W} + m ) , m = 0 , 1 , 2 , … \frac{{N}_{ifft} * {N}_{C S}}{{L}_{R A}} - 1 , k = 0 , 1 , 2 … N - 1$$

where m is the number of samples in an SW, N is the number of SWs, N_{SW} represents the length of an SW, and is calculated as follows:

$${N}_{SW} = \frac{{N}_{ifft} * {N}_{C S}}{{L}_{R A}}$$

Step 2.5: Obtain the power delay profile (PDP) of the preamble signal in each SW, and the PDP of the k-th SW is pₖ, expressed as follows:

$${p}_{k} = {\vert {x}_{k} \vert}^{2}$$

Step 3: BS obtains the number of detection windows for a corresponding RAPID according to the restricted set resource configuration restrictedSetConfig in step 1. Then, based on the number of detection windows, the target window is obtained, recorded as w_{target}.

The method for obtaining the number of detection windows for a corresponding RAPID is:
when restrictedSetConfig is configured as restrictedSetTypeA, it means that a high-speed cell uses restricted set A, the corresponding number of detection windows is 3, and the corresponding windows are recorded as w_{c}_{ᵥ}, w_{c}_{ᵥ}_{-d}_{ᵤ}, w_{c}_{ᵥ}_{+d}_{ᵤ} respectively; when restrictedSetConfig is configured as restrictedSetTypeB, it means that a high-speed cell uses restricted set B, the corresponding number of detection windows is 5, and the corresponding windows are recorded as w_{c}_{ᵥ}, w_{c}_{ᵥ}_{-d}_{ᵤ}, w_{c}_{ᵥ}_{+d}_{ᵤ}, w_{c}_{ᵥ}_{-2*d}_{ᵤ}, w_{c}_{ᵥ}_{+2*d}_{ᵤ}, respectively; where the cyclic shift value cᵥ=vN_{CS}, v=0, 1, 2, . . .

$$\frac{{L}_{RA}}{{N}_{CS}} - 1 ,$$

dᵤ is the cyclic shift value corresponding to the Doppler frequency offset defined by 3GPP. When restrictedSetConfig is configured as unrestrictedSet, it means that a non-high-speed cell uses the unrestricted set, the corresponding number of detection windows is 1, and the corresponding window is recorded as w_{c}_{ᵥ}.

The method for obtaining the target window is:
When the number of detection windows is 1, w_{c}_{ᵥ} is w_{target}, jump to step 4.
When the number of detection windows is greater than 1, the BS first calculates the similarity between individual detection windows and combines the detection windows with a similarity to obtain w_{targe}t.

To calculate the similarity between the individual detection windows, the detection window where the maximum PDP value is located among the detection windows may be selected as the standard window, denoted as w_{standard}. Based on w_{standard}, the cosine similarity γ between the remaining detection windows and w_{standard} is calculate.

For example, assuming w_{c}_{ᵥ} is w_{standard}, the calculation of γ between w_{c}_{ᵥ}_{-d}_{ᵤ} and w_{standard} is as follows:

$$γ = {\sum }_{m = 0}^{N s w - 1} \frac{\begin{matrix}( Re ( {w}_{{c}_{v}} ( m ) ) \times R e ( {w}_{{c}_{v} - {d}_{u}} ( m ) ) + \\ I m ( {w}_{{c}_{v}} ( m ) ) \times I m ( {w}_{{c}_{v} - {d}_{u}} ( m ) ) )\end{matrix}}{\begin{matrix}\sqrt{{\vert Re ( {w}_{{c}_{v}} ( m ) ) \vert}^{2} + {\vert I m ( {w}_{{c}_{v}} ( m ) ) \vert}^{2}} \times \\ \sqrt{{{\vert Re ( {w}_{{c}_{v} - {d}_{u}} ( m ) ) \vert}^{2} + \vert I m ( {w}_{{c}_{v} - {d}_{u}} ( m ) ) \vert}^{2}}\end{matrix}}$$

where, w_{c}_{ᵥ}(m) is the CDP value of the m-th sample within w_{c}_{ᵥ}. Re(·) represents the real part, Im(·) represents the imaginary part.

The Euclidean distance between the remaining detection windows and w_{standard} may also be calculated as the similarity metric value γ.

$$γ = {\sum }_{m = 0}^{N s w - 1} \sqrt{\begin{matrix}{\vert Re ( {w}_{{c}_{v}} ( m ) ) - Re ( {w}_{{c}_{v} - {d}_{u}} ( m ) ) \vert}^{2} + \\ {\vert I m ( {w}_{{c}_{v}} ( m ) ) - I m ( {w}_{{c}_{v} - {d}_{u}} ( m ) ) \vert}^{2}\end{matrix}}$$

Afterwards, the BS compares γ with a predefined threshold Thrₛᵢₘ, and if r>Thrₛᵢₘ, it is considered that there is similarity between w_{c}_{ᵥ}_{-d}_{ᵤ} and w_{c}_{ᵥ}; otherwise it is considered that there is no similarity between w_{c}_{ᵥ}_{-d}_{ᵤ} and w_{c}_{ᵥ}.

BS combines windows with similarity to obtain w_{target}, and discards detection windows without similarity; when the number of detection windows with similarity is zero, w_{standard} is w_{target}.

The combining method may be coherent combining based on PDP or combining based on CDP.

Assuming there is similarity between w_{c}_{ᵥ}_{-d}_{ᵤ} and w_{c}_{ᵥ},

The coherent combining method based on PDP is as follows:

$${w}_{target , PDP} ( m ) = \sqrt{{\vert Re ( {w}_{{c}_{v}} ( m ) ) \vert}^{2} + {\vert I m ( {w}_{{c}_{v}} ( m ) ) \vert}^{2}} + \sqrt{{\vert Re ( {w}_{{c}_{v} - {d}_{u}} ( m ) ) \vert}^{2} + {\vert I m ( {w}_{{c}_{v} - {d}_{u}} ( m ) ) \vert}^{2}}$$

Where w_{target, PDP}(m) represents the PDP value of the m-th sample within w_{target}.

The combining method based on CDP is as follows:

$${w}_{target , CDP} ( m ) = Re ( {w}_{{c}_{v}} ( m ) ) + Re ( {w}_{{c}_{v} - {d}_{u}} ( m ) ) + 1 j * ( I m ( {w}_{{c}_{v}} ( m ) ) + I m ( {w}_{{c}_{v} - {d}_{u}} ( m ) ) )$$

where w_{target, CDP}(m) represents the CDP value of the m-th sample within the w_{target}, and 1j represents the imaginary unit.
Step 4, the BS performs a preprocessing operation and a candidate user signal cluster identification operation on w_{target}, and obtains time distribution characteristics of channel and possible user signal clusters for w_{target}, to identify possible UEs within w_{target}. The preprocessing operation includes the following multiple stages or modes or operations; a candidate user signal cluster represents a time window in which a single UE may present, that is, the distinguishability in time between different UEs, and the number of possible user signal clusters represents the number of possible UEs.
Step 4.1: Data preprocessing operation. The main purpose of this operation is to determine candidate multi-user signal clusters, determine the separation point between signal and noise at the same time, and perform noise power calculation based on the result of the separation point.

First, perform a sorting operation on the PDP values in w_{target} to obtain a sorted target window, which is denoted as w_{target}_{ₛₒᵣₜ}, and record the index Ψm of the original sequence corresponding to the sorted sequence. The sorting operation may be descending or ascending.

$${w}_{{target}_{sort} , PDP} = sort ( {w}_{target , PDP} , descending / ascending ) , m = 0 , 1 , 2 … {N}_{S W} - 1$$

where, ψm=f−1(m), f−1(·) is the mapping function from an index after sorting to an index before sorting.

Secondly, perform N_{order}-order differential operation on w_{target}_{ₛₒᵣₜ}_{,PDP} to obtain a differential sequence of length N_{SW}−N_{order} The separation point between signal and noise is determined through the differential sequence result, the N_{order} may be 1 or 2.

The first-order differential sequence is denoted as ∇₁w_{target}_{ₛₒᵣₜ}_{,PDP}, which is expressed as follows:

$${∇}_{1} {w}_{{target}_{s o r t} , P D P} ( m ) = {w}_{{target}_{sort} , PDP} ( m + 1 ) - {w}_{{target}_{s orr} , PDP} ( m ) , m = 0 , 1 , … {N}_{S W} - 2$$

where, ∇₁w_{target}_{ₛₒᵣₜ}_{,PDP}(m) represents the PDP value of the m-th sample of the first-order differential sequence of w_{target}_{ₛₒᵣₜ}.

The second-order differential sequence ∇₂w_{target}_{ₛₒᵣₜ}_{,PDP} is expressed as:

$${∇}_{2} {w}_{{target}_{sort} , PDP} ( m ) = {∇}_{2} {w}_{{target}_{sort} , PDP} ( m + 1 ) - {∇}_{2} {w}_{{target}_{sort} , PDP} ( m ) , m = 0 , 1 , … {N}_{SW} - 3$$

where, ∇₂ w_{target}_{ₛₒᵣₜ}_{,PDP}(m) represents the PDP value of the m-th sample of the second-order differential sequence of w_{target}_{ₛₒᵣₜ}.

The method for determining the separation point between signal and noise may be by comparing the above differential result ∇_{N_order}w_{target}_{ₛₒᵣₜ}_{,PDP} with a predefined threshold threshold, to find the starting index value \tilde{k} within ∇_{N_order}w_{target}_{ₛₒᵣₜ}_{,PDP} starting from which the PDP value is always smaller than the threshold threshold, that is, the separation point between noise and signal.

The separation point between signal and noise may also be determined by comparing the sequence ∇_{N}_{_{order}}_{,MA} obtained by performing a moving average on ∇_{N_order}w_{target}_{ₛₒᵣₜ}_{,PDP} with a predefined threshold threshold, to find the starting index value \tilde{k} within ∇_{N}_{_{order}}_{,MA} starting from which the PDP value is always smaller than the threshold threshold, that is, the separation point between noise and signal.

The moving average result sequence ∇_{N}_{_{order}}_{,MA} of the N_order-order differential may be expressed as:

$${∇}_{{N}_{o r d e r} , MA} ( m ) = {\sum }_{m = 0}^{{N}_{S W} - {N}_{o r d e r} - {L}_{w}} ( {∇}_{{N}_{o r d e r}} {w}_{{target}_{sort} , PDP} ( m ) + … + {∇}_{N \_ order} {w}_{{target}_{sort} , PDP} ( m + {L}_{w} ) ) / {L}_{w}$$

Where L_{W} is a predefined length of the moving average window.

Again, based on the obtained signal and noise separation point \tilde{k}, the noise power σ is calculated, the calculation of σ may be expressed as:

$$σ = \frac{{\sum }_{m = \tilde{k}}^{{N}_{SW} - 1} {w}_{t a r g e {t}_{s o r t} , PDP} ( m )}{{N}_{SW} - \tilde{k}}$$

Step 4.2: Obtain candidate multi-user signal clusters within w_{target} based on ψₘ and \tilde{k}. The method for obtaining candidate multi-user signal clusters includes the following multiple stages or modes or operations:
First, obtain the index of signal before sorting through the index corresponding to the sorted signal; In FIG. 5, the corresponding index of signal before sorting is [2, 3, 4, 5, 10, 12, 14, 16, 25, 26, 27, 28]

$$\tilde{J} ( i ) = {ψ}_{m} ( i ) , i = 0 , 1 , 2 , … \tilde{k}$$

Secondly, match \tilde{j} into w_{target} in sequence, and obtain the FFT upsampling clusters according to FFT upsampling; shown in FIG. 5 are 3 FFT clusters;
Next, based on the FFT clusters, find the maximum peak value of the PDP as the center of the maximum delay spread cluster, and obtain the maximum delay spread cluster based on the maximum delay spread value. FIG. 6 illustrates one maximum delay spread cluster;
Finally, according to the attenuation characteristics of amplitude of a multipath channel, clusters that do not conform to the attenuation characteristics are identified as individual user signal clusters, as shown in FIG. 7, which are 2 candidate multiuser signal clusters.

On the final acquisition of the above candidate user signal clusters, further screening may be in combination with the distribution of UEs in the cell, may be in combination with preamble resources, may be in combination with BS scheduling and processing capabilities, and may also be based on the signal index j of adjacent user signal clusters.

For example, when the UE number in a cell is large and the uplink resources currently used for scheduling are limited, the BS may limit the number of candidate user signal clusters;
When the distance between the first path signal \tilde{j}ᵢ corresponding to the i-th user signal cluster and the first path signal \tilde{j}ᵢ₊₁ corresponding to the i+1-th user signal cluster is less than a predefined threshold T, \tilde{j}ᵢ₊₁−\tilde{j}ᵢ<T, the adjacent user signal clusters are considered to correspond to the same UE.
Step 5: Perform feature screening and/or feature reconstruction on each candidate user signal cluster, as input to the subsequent AI model to perform inference, and the AI model outputs whether a UE is detected in the candidate user signal cluster.

The feature screening is to extract consecutive \tilde{L}(1≤\tilde{L}<Lₛₜₑₚ) PDP signals in the candidate user signal cluster, where \tilde{L} is a predefined value. For example, \tilde{L} may be selected based on the tolerance interval L_{TA_error_toler} of TA detection error, using Lₛₜₐᵣₜ of the candidate user signal cluster as the starting point to extract consecutive L_{TA_error_toler} continuous signals as features, denoted as S_{feature}, as input to the AI model:

$${S}_{feature} = [ {L}_{start} , {L}_{start} + 1 , … {L}_{start} + {L}_{TA \_ error \_ toler} ]$$

L_{TA_error_toler} continuous signals may also be extracted as features to the AI model based on Lₛₜₐᵣₜ of the candidate user signal cluster as the central or middle point:

$${S}_{feature} = [ {L}_{start} - \frac{{L}_{{TA}_{e r r o {r}_{t o l e r}}}}{2} , … {L}_{start} + 1 , … {L}_{start} + \frac{{L}_{T {A}_{e r r o {r}_{t o l e r}}}}{2} ]$$

The feature reconstruction is to construct other characteristics of the signal based on S_{feature}. For example, the peak average power ratio (PAPR) may be constructed, or the variance of the signal may be constructed. The constructed characteristic may be one or more.

PAPR-based feature construction may be expressed as:

$${f}_{feature} = [ {S}_{feature} , PAPR ]$$

$$PAPR = \frac{{max}_{i} {S}_{feature}}{\overline{{S}_{feature}}} , i = 0 , 1 , 2 … , {L}_{{TA}_{e r r o {r}_{t o l e r}}} + 1$$

Where S̅_̅{̅f̅e̅a̅t̅u̅r̅e̅}̅ is the average value of PDPs in S_{feature}
Step 6: Add confidence to the output of the AI model to improve the robustness of the detection performance.

For example, when the AI model uses sigmoid for decision output, add signal noise ratio (SNR)-based confidence to the sigmoid to obtain an improved decision output E_g(z).
where, E_g(z) is expressed in the following form:

$$E\_g ( z ) = min ( max ( \frac{1}{1 + {e}^{- z}} * ( 1 - \frac{Noise}{max\_peak} ) , 0 ) , 1 )$$

$$Where SNR is \frac{max\_peak}{Noise}$$

Finally, a threshold comparison is made on E_g(z), when E_g(z)<Thr, it means that no UE is detected in the candidate user signal cluster; on the contrary, when E_g(z)>Thr, it means that a UE is detected in the candidate user signal cluster, and the first path of the signal in this candidate user signal cluster is TA. The predefined value Thr may be set to 0.5.

Based on this, the larger the SNR, the more reliable the detection result; on the contrary, the smaller the SNR, the smaller the reliability of the detection result.

By adopting an adaptive combining method for multiple detection windows for HST scenarios, the embodiment optimizes the miss detection problem caused by power dispersion in Doppler effect, also improves the false alarm problem caused by static combining of multiple detection windows in noise environment, and improves the detection performance as a whole.

In this embodiment, the candidate user signal clusters will be further screened according to the index distribution of the initial judgment results, thereby improving the false positive and false alarm performance of multi-UE detection.

In this embodiment, the accuracy of TA estimation is achieved by selecting the first signal path in each candidate user signal cluster as the TA for this UE.

In one or more embodiments, after the BS receives the Preamble, the BS obtains detection information corresponding to multiple UEs for the same RAPID through the detection algorithm. Based on the obtained detection information, the BS configures to the UE, RAR information which is used for the UE to perform RAR scheduled PUSCH transmission, or is referred to as information of PUSCH transmission as mentioned above or first information. The RAR information includes RAPID, the UE number for the same RAPID, optional DMRS resource indication, TA, TA obtaining indication, T-CRNTI, UL Grant resource, etc., and the information is configured to the UE in a MAC RAR PDU. In an implementation, the above RAR information or referred to as information of PUSCH transmission is transmitted to the UE through message 2 (Msg2), the Msg2 may include PDCCH and PDSCH RAR, and the information of the PUSCH transmission may be transmitted to the UE through the PDCCH and/or PDSCH RAR of Msg2.

The MAC RAR PDU consists of one or more RAR subPDUs, one or more multi RAR subPDUs and optional padding.

This embodiment will introduce a method for the BS side to configure the random access response MSG2 RAR in a multi-UE scenario. In this method, the RAR information is configured in the MAC RAR PDU and transmitted to the UE through the PDSCH.

Assume that the BS detects N UEs with the same RAPID, N>1.

Among them, the UE number N and optional DMRS resource information are configured in the UE information field in the RAR subheader, and the numbers of occupied bits are denoted as bit_{UE_N} and bit_{DMRS} respectively. TA, T-CRNTI, and UL Grant resource information are respectively configured in the TAC, T-CRNTI, and UL Grant fields in the RAR payload, and the numbers of occupied bits are denoted as, bit_{TAC}, bit_{TCRNTI} and bit_{UL_Grant} respectively.

$${bit}_{UE \_ N} = {log}_{2} N bit .$$

The optional DMRS resource information, when configured, is placed in the least significant bits next to the UE number information, bit_{DMRS}=N log₂ N.

Optional DMRS resource information. When not configured, the UE information field only contains UE number information.

The number of bits occupied by the UE information field is bit_{subheader}=bit_{DMRS}+bit_{UE_N}, and the number of bytes occupied is

$${byte}_{s u b h e a d e r} = ⌈ \frac{b i {t}_{s u b h e α d e r}}{8} ⌉ .$$

The vacant byte_{subheader}×8−bit_{subheader} most significant bits of RAR subheader are configured as the Reserved field.

For example, the optional DMRS resource information, when configured,

$${byte}_{s u b h e a d e r} = ⌈ \frac{{log}_{2} N + N {log}_{2} N}{8} ⌉ ,$$

the byte_{subheader}×8−log₂ N−N log₂ N most significant bits of
the RAR subheader are configured as the Reserved field.

Optional DMRS resource information, when not configured,

$${byte}_{s u b h e a d e r} = ⌈ \frac{{log}_{2} N}{8} ⌉ ,$$

the byte_{subheader}×8−log₂ N most significant bits of the RAR subheader are configured as the Reserved field.

TA information may be configured as absolute TA values, and individual TA values are arranged in a first order, such as in ascending or descending order, bit_{TAC}=12N bit;

It may also be configured as a reference TA S_{TA} (or referred to as a second TA, a reference TA, a standard TA, etc. shown as a reference TA in the figure) and the remaining N−1 relative TAs Δ_{TA} (or referred to as difference TAs, TA differences, etc.), where S_{TA} may be selected as the minimum or maximum TA value among the individual TA values, occupying 12 bits, and Δ_{TA} are the differences of the remaining N−1 absolute TA values relative to S_{TA}, each occupying 8 bits, bit_{TAC}=12+(N−1)×8.

The calculation of Δ_{TA} is expressed as follows:

$${Δ}_{TA} = \frac{\vert TA - {S}_{TA} \vert}{{unit}_{TA}}$$

where, unit_{TA} is the minimum time interval at which the BS side detection algorithm may identify different UEs. For example, the maximum delay spread may be selected as unit_{TA}.

UL Grant may be configured as N orthogonal scheduling information, bit_{UL_Grant}=N*27 bits. It may also be configured as the same set of scheduling information, bit_{UL_Grant}=27 bits.

T-CRNTI is configured as N randomly different values, bit_{TCRNTI}=N*16 bits.

In the PDSCH RAR payload field, the number of occupied bytes is

$${byte}_{RAR \_ payload} = ⌈ \frac{{bit}_{TAC} + {bit}_{ULGrαnt} + {bit}_{TCRNTI}}{8} ⌉ ,$$

and the byte_{RAR_payload}×8−(bit_{TAC}+bit_{UL}_{_{Grant}}+bit_{TCRNTI}) most significant bits of the RAR payload are set to Reserved.

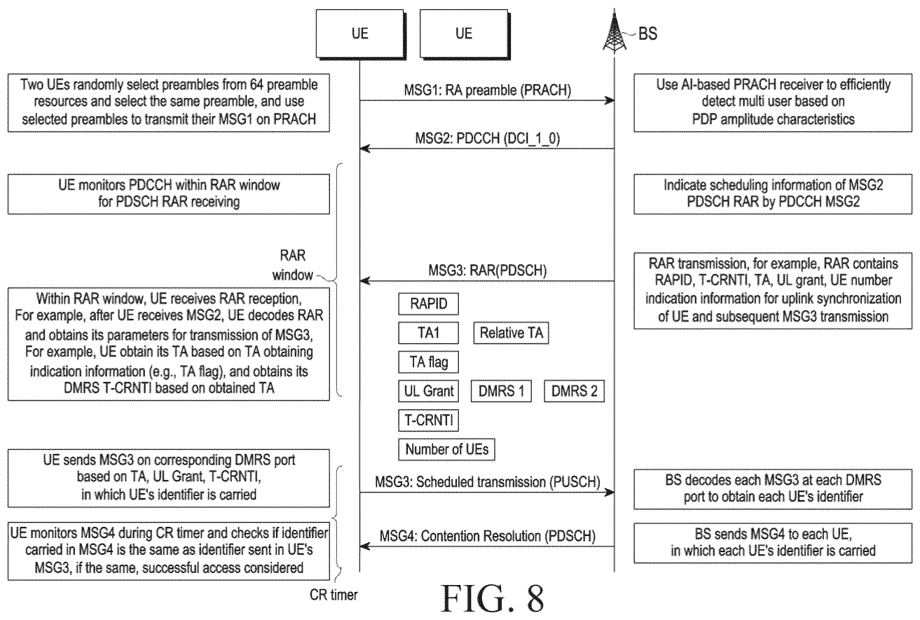

FIGS. 9-16 respectively illustrate examples of this embodiment in different configurations, and the examples assume N=2.

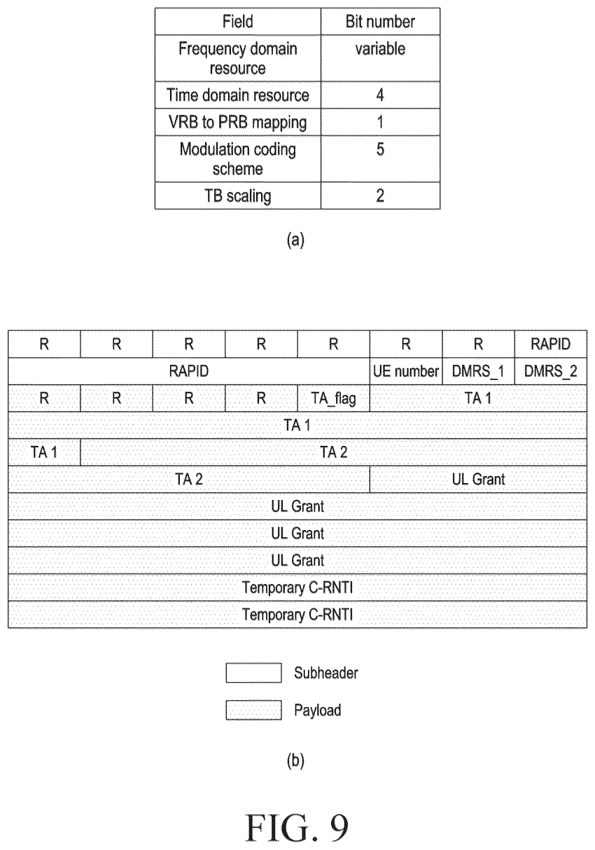

For example, (a) in FIG. 9 and FIGS. 11-16 illustrates a schematic diagram of fields of DCI in the PDCCH scheduling PDSCH of RAR in this embodiment. In (a) in FIG. 9 and FIGS. 11-16, “VRB” means virtual resource block and “PRB” means a physical resource block. (b) in FIG. 9 and FIGS. 11-16, and FIG. 10 illustrate various different examples of configuring the RAR information in the sub-PDU (subPDU) of the RAR PDSCH, where it is assumed that 2 UEs are detected for the same RAPID. For example, the RAPID corresponding to the sub-PDU shown in the figure may be included in the sub-header of the sub-PDU, such as in the RAPID sub-header.

In addition, although only the RAR sub-PDU corresponding to one RAPID is shown in FIGS. 9-16, this is only for convenience of description. It may be understood that the PDU may include multiple RAR sub-PDUs of structure similar to the structure shown in FIGS. 9-13, each sub-PDU corresponding to a different RAPID. The sub-PDU corresponding to each RAPID may include the above-mentioned RAR information about one or more UEs corresponding to the RAPID.

It may be understood from this that for the case where the UE number corresponding to RAPID is 1, the sub-PDU may not include the UE number (UE number in various schematic diagrams of this disclosure), and such a sub-PDU may be referred to as RAR subPDU; alternatively, regardless of whether the UE number corresponding to RAPID is 1 or not, the UE number is included in the sub-PDU, and such a sub-PDU may be referred to as a multi-RAR sub-PDU. Alternatively, a sub-PDU includes the UE number and RAR-related information of multiple UEs, such as the above-mentioned TA, optional DMRS resource indication, T-CRNTI, etc., then such a sub-PDU is referred to as a multi RAR subPDU. In addition, an RAR including information related to uplink transmission of multiple UEs or an RAR including information related to RARs of multiple UEs may be referred to as a multi RAR, and the corresponding sub-PDU is referred to as a multi RAR subPDU.

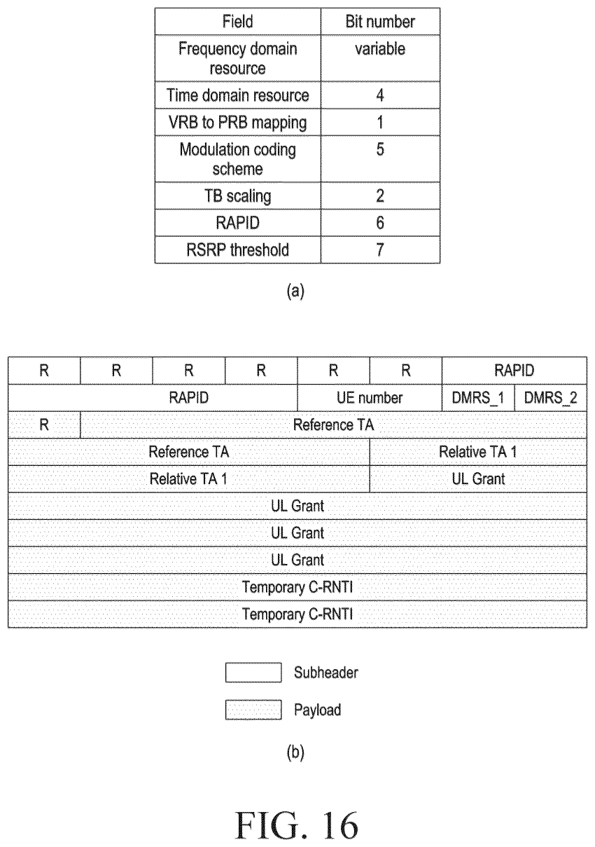

FIG. 17 illustrates an example structure diagram of a MAC PDU according to embodiments of the present disclosure. As shown in FIG. 17, the MAC PDU may include multiple sub-PDUs (subPDUs) and optional padding bits, such as MAC subPDU1 to MAC subPDUn, Padding (opt) shown in the figure. Some of the sub-PDUs may be MAC RAR subPDUs (such as subPDU3 in the figure), and some sub-PDUs may be MAC multi RAR subPDUs (such as subPDU4 in the figure).

A different MAC RAR subPDUs may be used for a different RAPID corresponding to one UE; Different MAC multi RAR subPDUs may be used for different RAPIDs, where each of these RAPIDs corresponds to multiple UEs.

RAR subPDU may include RAPID and RAR information.

According to embodiments of the present disclosure, a subheader dedicated to UE information (for example, referred to as UE information subheader) may be included in the multi RAR subPDU. The multi RAR subPDU may include UE information subheader and multi RAR, the multi RAR includes information related to uplink transmission of multiple UEs, such as TA information, uplink resource configuration information, T-CRNTI, optional DMRS resource indication, etc.

(b) in FIG. 9 illustrates that in the sub-PDU, the RAPID, the number of UEs (UE number in the figure) and the DMRS resource indication (DMRS_1, DMRS_2, etc. in various schematic diagrams of the present disclosure) in the RAR information are carried by a subheader, and the subheader may be a subheader for RAR information or for UE information, for example, shown as subheader in various schematic diagrams of the present disclosure, but may also be other names. (b) in FIG. 9 also illustrates that the payload of the sub-PDU (payload in various schematic diagrams of the present disclosure) carries TA obtaining indication information (shown as TA_flag in the figure), absolute TA information (TA1, TA2, etc. in various schematic diagrams of the present disclosure), uplink resource configuration information (UL grant, etc. in various schematic diagrams of the present disclosure), T-CRNTI (Temporary C-RNTI, etc. in various schematic diagrams of the present disclosure).

FIG. 10 illustrates that the subheader of the PDU carries RAPID, UE number and DMRS resource indication, and the payload of the sub-PDU carries reference TA information (reference TA in various schematic diagrams of this disclosure), relative TA information (relative TA 1, etc. in various schematic diagrams of this disclosure), uplink resource configuration information, T-CRNTI.

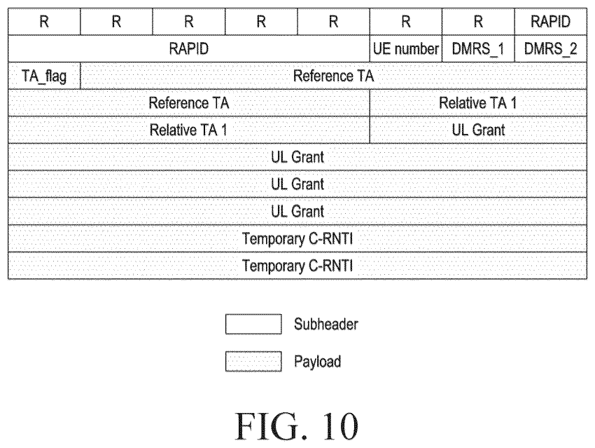

(a) in FIG. 11 illustrates that RAPID is carried in the DCI of message 2, (b) in FIG. 11 illustrates that RAPID, UE number, and DMRS resource indication are carried in the subheader of the PDU, and TA obtaining indication information (shown as TA_flag in the figure), reference TA information (reference TA in the figure), relative TA information (relative TA 1 in the figure), uplink resource configuration information (UL grant in the figure), T-CRNTI (Temporary C-RNTI in the figure) are carried in the payload of the sub-PDU.

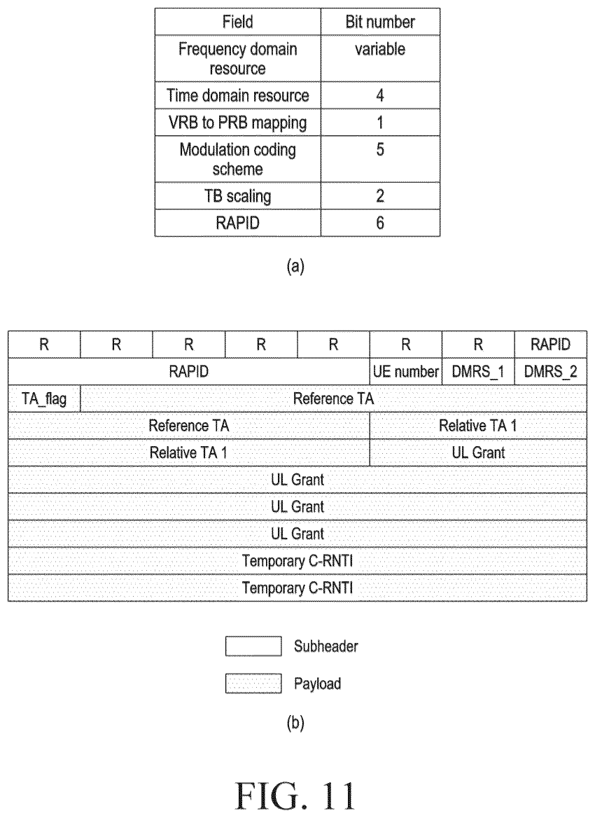

(a) in FIG. 12 illustrates that RAPID, UE number, and reference TA (reference TA in the figure) are carried in the DCI of message 2, and (b) in FIG. 12 illustrates that RAPID, DMRS resource indication are carried in the subheader of the PDU, and TA obtaining indication information (shown as TA_flag in the figure), relative TA information (relative TA 1 in the figure), uplink resource configuration information (UL grant in the figure), T-CRNTI (Temporary C-RNTI in the figure) are carried in the payload of the sub-PDU.

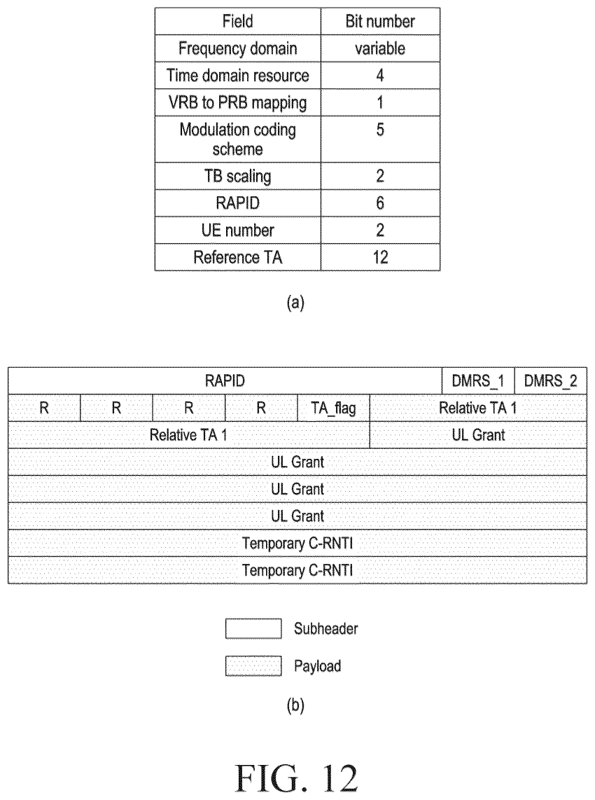

(a) in FIG. 13 illustrates that RAPID, UE number, reference TA (reference TA in the figure) and threshold (such as RSRP threshold in the figure) are carried in the DCI of message 2, (b) in FIG. 13 illustrates that RAPID and DMRS resource indication are carried in the subheader of the PDU, and TA obtaining indication information (shown as TA_flag in the figure), threshold offset value (for example, RSRP_offset in the figure), relative TA information (relative TA1 in the figure), uplink resource configuration information (UL grant in the figure), T-CRNTI (Temporary C-RNTI in the figure) are carried in the payload of the sub-PDU.

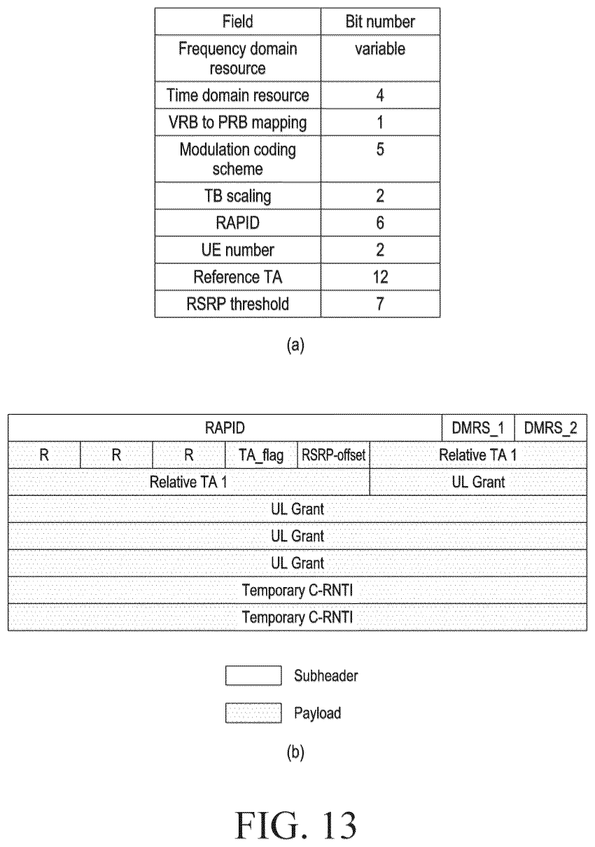

(a) in FIG. 14 illustrates that RAPID, UE number, reference TA (reference TA in the figure) and TA obtaining indication information (shown as TA_flag in the figure) are carried in the DCI of message 2, (b) in FIG. 14 illustrates that RAPID and DMRS resource indication are carried in the subheader of the PDU, and relative TA information (relative TA1 in the figure), uplink resource configuration information (UL grant in the figure), T-CRNTI (Temporary C-RNTI in the figure) are carried in the payload of the sub-PDU.

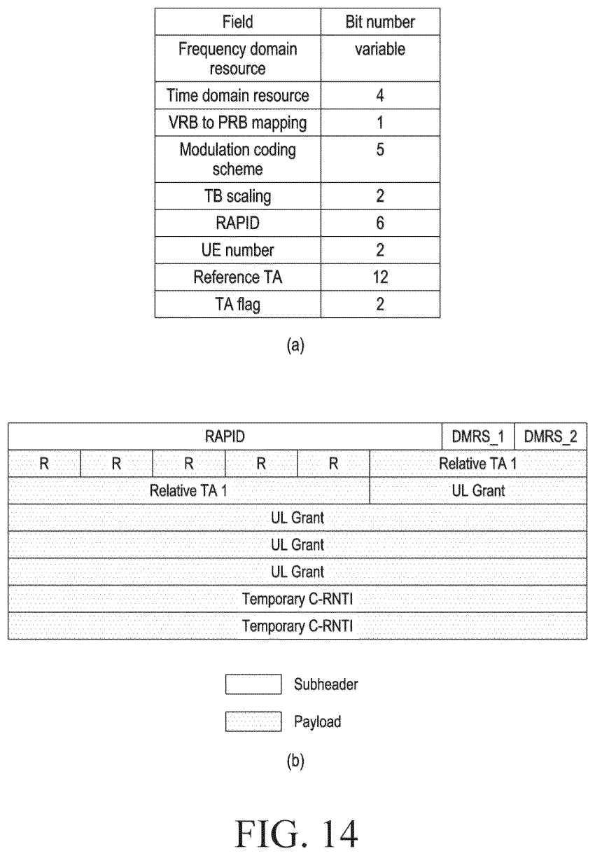

(a) in FIG. 15 illustrates that RAPID, UE number, reference TA (reference TA in the figure), TA obtaining indication information (shown as TA_flag in the figure) and threshold (for example, RSRP threshold in the figure) are carried in the DCI of message 2, (b) in FIG. 15 illustrates that RAPID and DMRS resource indication are carried in the subheader of the PDU, and the threshold offset value (for example, RSRP-offset in the figure), relative TA information (relative TA 1 in the figure), uplink resource configuration information (UL grant in the figure), T-CRNTI (Temporary C-RNTI in the figure) are carried in the payload of the sub-PDU.

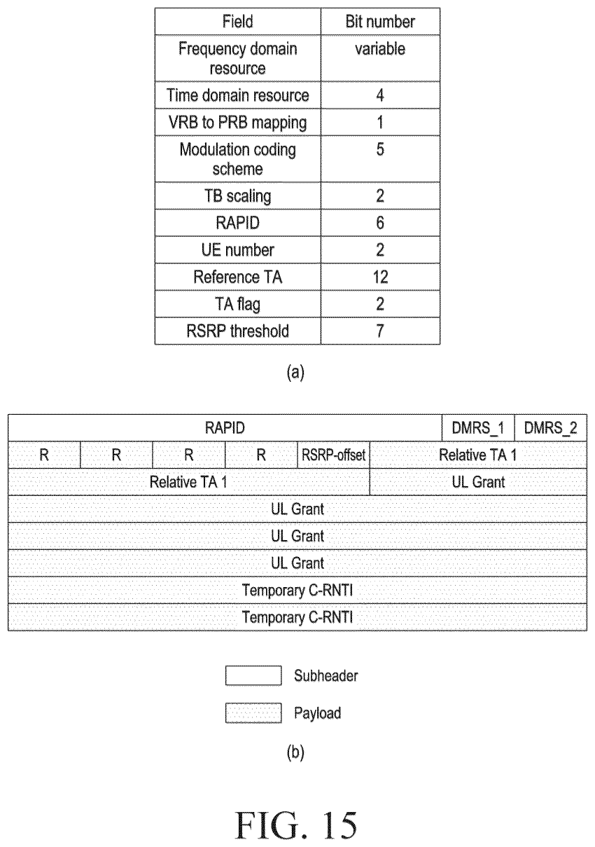

FIG. 16 illustrates a schematic diagram of RAR information being jointly configured in DCI 1_0 and MAC RAR PDU according to an embodiment of the present disclosure. (a) in FIG. 16 illustrates that DCI 1_0 of message 2 carries RAPID and absolute threshold information (shown as RSRP threshold in the figure). (b) in FIG. 16 illustrates that 2 UEs are detected for one RAPID, DMRS, UE number are configured in the MAC PDU, and the TAC field is configured with the reference TA and relative TA values. In addition, in this design, DMRS is used for the base station to identify overlapping UL grant resources; All UEs identified for this RAPID have the same UL grant; The T-CRNTI field indicates the T-CRNTI of the reference UE.

It should be understood that although the figures illustrate that the DCI or PDU of MSG2 includes TA obtaining indication information, this is only an example, and MSG2 may not include TA obtaining indication information or the field related to TA obtaining indication information. In this case, it may be considered to use a method of enabling threshold-based acquisition of TA estimate as a default or preset method. The UE may obtain the TA estimate based on threshold related information (e.g., RSRP threshold, or RSRP threshold and threshold offset information). Alternatively, in some embodiments, the solution in which the TA obtaining indication information is included in the payload of the sub-PDU may also be replaced by the TA obtaining indication information being included in the subheader of the PDU.

In this embodiment, multi-UE detection information being configured in random access response is implemented by designing multi-RAR, which is the key to conflicting UEs being possible to access simultaneously.

In this embodiment, resource overhead is saved by way of joint configuration of S_{TA} and Δ_{TA} compared with configuration of absolute TA information.

In this embodiment, through the sorting design in the TAC field, the time for the UE to search and select TA is sped up, and the UE power consumption is reduced.

In this embodiment, the same set of UL_Grant scheduling information is configured for individual UEs, and individual UEs are distinguished through orthogonal DMRS resources or randomization of T-CRNTI. Compared with configuring orthogonal UL Grant scheduling information for individual UEs, uplink resources are saved.

One or more embodiments of the present disclosure provide a configuration method for the BS side to transmit the random access response MSG2 RAR in a multi-UE scenario. The RAR information in this method is configured in PDCCH (e.g., DCI 1_0) and MAC RAR PDU, transmitted to the UE through PDCCH and PDSCH.

Assume that the BS detects N UEs with the same RAPID, N>1. The number of such RAPID groups is M.

The RAPID in the RAR information is configured in the least significant bits of the DCI 1_0 field, occupying the number of bits bit_{RAP}ID=6M.

Other information is configured in the subheader or payload of PDSCH RAR. The other information includes the UE number N, optional DMRS resources, TA, T-CRNTI, and UL Grant resources, and the configuration method is not repeated here as it has been described above.

FIG. 11 illustrates an example of the configuration in this embodiment, which assumes the UE number corresponding to RAPID N=2. (a) in FIG. 11 illustrates a schematic diagram of the fields in DCI 1_0, where it is assumed that the RAPID field indicates 2 different RAPIDs, each RAPID being indicated by 6 bits. (b) in FIG. 11 illustrates the configuration situation of the sub-PDU for one of the RAPIDs, where it is assumed that this RAPID corresponds to 2 UEs.

In this embodiment, by configuring RAPID in the DCI1_0 field, the UE may start estimating or obtaining its own TA in advance after decoding the PDCCH, thereby improving access delay and achieving low power consumption on the UE side.

In this embodiment, by configuring RAPID in the DCI 1_0 field, the Reserved field of the PDCCH is fully utilized and resource utilization is improved.

One or more embodiments provide a configuration method for the BS side to transmit the random access response MSG2 RAR in a multi-UE scenario. The RAR information in this method is configured in PDCCH DCI1_0 and MAC RAR PDU, and is transmitted to the UE through PDCCH and PDSCH.

Assume that the BS detects N UEs with the same RAPID. The number of such RAPID groups is M.

The RAPID and UE number in the RAR information are configured in the DCI1_0 field.

The RAPID configuration is not repeated here as it has been described above. The UE number is placed next to the RAPID in the least significant bits of DCI1_0, bit_{UE_N}=M log₂ N, occupying a total of M×(6+log₂ N) bits.

Other information is configured in the subheader or payload of PDSCH RAR. The other information includes, optional DMRS resources, TA, T-CRNTI, and UL Grant resources, and the configuration method is not repeated here as it has been described above.

Among them, the optional DMRS resource information is configured in the UE information field in the RAR subheader, and the number of bits occupied is denoted as bit_{DMRS}.

Optional DMRS resource information, when configured, bit_{DMRS}=N log₂ N, the number of occupied bytes

$${byte}_{s u b h e a d e r} = ⌈ \frac{{bit}_{DMRS}}{8} ⌉ .$$

The vacant byte_{subheader}×8−bit_{DMRS} most significant bits of RAR subheader are configured as the Reserved field.

The configuration method of TA, T-CRNTI, and UL_Grant resource information is not repeated here as it has been described above.

FIG. 12 illustrates an example of configuration in this embodiment, which assumes that the UE number corresponding to a certain RAPID corresponds to N=2. (a) in FIG. 12 illustrates a schematic diagram of the fields in DCI 1_0, where it is assumed that the RAPID field indicates 2 different RAPIDs and their corresponding UE number, each RAPID is indicated by 6 bits, and each UE number is indicated by 2 bits. (b) in FIG. 12 illustrates the configuration situation of the sub-PDU for one of the RAPIDs, where it is assumed that this RAPID corresponds to 2 UEs. In an implementation, in the DCI field, the bits of each RAPID and its corresponding UE number are placed adjacent to each other, or the bits of all RAPIDs are placed adjacent to each other, the bits of all UE numbers are placed adjacent to each other, and there is a corresponding relationship between the locations of the bits of individual RAPIDs and the bits of the UE number corresponding thereto. For example, the order for placing the bits of the UE numbers is consistent with the order for placing the bits of the corresponding RAPIDs.

In this embodiment, by configuring RAPID in the DCI 1_0 field, the UE may start estimating or obtaining its own TA in advance after decoding the PDCCH, thereby improving access latency and achieving low power consumption on the UE side.

In this embodiment, by configuring the UE number in the DCI 1_0 field, the UE may start calculating the PDSCH payload length that needs to be decoded in advance after decoding the PDCCH, thereby improving the access latency and achieving low power consumption on the UE side.

One or more embodiments provide a configuration method for the BS side to transmit the random access response MSG2 RAR in a multi-UE scenario. The RAR information in this method is configured in PDCCH DCI1_0 and MAC RAR PDU, and is transmitted to the UE through PDCCH and PDSCH.

Assume that the BS detects N UEs with the same RAPID, N>1. The number of such RAPID groups is M.

The RAPID, the UE number N and S_{TA} (alternatively referred to as reference TA or standard TA, shown as reference TA in the figure) in the RAR are configured in the DCI1_0 field, and the description of S_{TA} is the same as S_{TA}

The configuration of RAPID and the UE number are not repeated here as they have been described above.

The S_{TA} is placed next to the UE number in the least significant bits of DCI1_0, and the number of occupied bits is bit_{S}_{_{TA}}=12M bits.

Other information is configured in the subheader or payload of PDSCH RAR. The other information includes, optional DMRS resources, N−1 instances of Δ_{TA}, T-CRNTI, and UL Grant resources. The description of Δ_{TA} is the same as Δ_{TA}.

Among them, the optional DMRS resource configuration method is not repeated here as it has been described above.

N−1 instances of Δ_{TA} information is configured in the TAC field of the RAR payload, the number of occupied bits bit_{Δ}_{_{TA}}=(N−1)×8.

The configuration method of T-CRNTI and UL Grant resource information is the same as the T-CRNTI and UL Grant configuration which have been described above.

In the PDSCH RAR payload field, the number of occupied bytes is

$${byte}_{R A {R}_{-} p a γ l o a d} = ⌈ \frac{{bit}_{{Δ}_{TA}} + {bit}_{UL \_ Grant} + {bit}_{TCRNTI}}{8} ⌉ ,$$

and the byte_{RAR_payload}×8−(bit_{Δ}_{_{TA}}+bit_{UL_Grant}+bit_{TCRNTI}) most significant bits of the RAR payload are set to Reserved.

FIGS. 12-13 illustrate sample configurations in this embodiment, which assume that the UE number corresponding to a certain RAPID corresponds to N=2.

(a) in FIGS. 12 and 13 illustrate a schematic diagram of the fields in DCI 1_0, where it is assumed that the RAPID field indicates that there are multiple UEs for this RAPID, and the DCI also includes information about the UE number corresponding to the RAPID and the reference TA. Each RAPID is indicated by 6 bits, each UE number is indicated by 2 bits, and each reference TA is indicated by 12 bits. In an implementation, in the DCI field, each RAPID is placed adjacent to its corresponding UE number bits and reference TA bits, or all RAPIDs are placed adjacent to each other, all UE number bits are placed adjacent to each other, all reference TA bits are placed adjacent to each other, and there is a corresponding relationship among the locations of the bits of individual RAPIDs and its corresponding UE number bits and reference TA bits, for example, the placement order of the UE number bits, the placement order of the reference TA bits are consistent with the placement order of the RAPID bits corresponding thereto.

In an implementation, as shown in (a) in FIG. 13, DCI 1_0 may also include threshold related information, such as the RSRP threshold shown in the figure, which may be indicated by 7 bits, for example. For example, the RSRP threshold may be used by the UE to determine the TA estimate, as previously described.

(b) in FIGS. 12 and 13 illustrate the configuration of sub-PDUs for one of the RAPIDs, assuming that this RAPID corresponds to 2 UEs. (b) in FIG. 12 illustrates that the payload part includes the relative TA information of the 2 UEs relative to the reference TA, and (b) in FIG. 13 illustrates that the payload part includes the relative TA information of the 2 UEs relative to the reference TA and a threshold offset value (such as RSRP-offset shown in the figure). In an implementation, as shown in (b) in FIGS. 12 and 13, the payload part of the sub-PDU may also include TA obtaining indication information (TA_flag as shown in the figure).

In an implementation, the payload part of the sub-PDU may include the threshold offset value and not include the TA obtaining indication information. In the absence of TA obtaining information, the UE obtains the TA estimate value based on the threshold by default. For example, the UE may perform TA estimation based on the threshold-related information (such as RSRP threshold) obtained from the DCI and the threshold offset value in the payload part of the sub-PDU. The specific method is as described above and will not be described again here.

In this embodiment, by configuring the reference TA S_{TA} in DCI 1_0, the UE may start estimating or obtaining its own TA before decoding the PDSCH, and by comparing with S_{TA}, estimate the general location of its own TA in the payload, which improves latency, and achieves low UE-end power consumption.

One or more embodiments provide the method for the UE side to receive the random access response RAR and obtain information of PUSCH transmission scheduled based on RAR in a multi-UE scenario. The information of PUSCH transmission includes UE number, optional DMRS resource indication, TA, TA obtaining indication information, T-CRNTI, and UL Grant resources.

The UE receives the RAR, specifically involving the following steps:
Step 1: Monitor PDCCH in the message waiting window ra-ResponseWindow to receive the RAR. RARs received by the UE within this window are considered valid; if the UE does not receive an RAR within the RAR time window, it is considered that this random access procedure has failed, and the UE retransmits the MSG1 Preamble. Wherein ra-ResponseWindow is configured by rar-WindowLength in the SIB message.
Step 2: After successfully decoding the PDCCH, the UE will obtain the RB resource information of the PDSCH RAR to receive the downlink transport block transmitted through the PDSCH, and optional detection result information. The optional detection result information includes optional RAPID, optional UE number, optional reference TA, and optional TA obtaining indication information. (a) in FIG. 14 illustrates a schematic diagram of fields in DCI 1_0.

When the PDCCH carries RAPID, the UE parses the 6M least significant bits of the PDCCH and checks whether the RAPID therein matches the RAPID transmitted by itself. If it matches, according to the TA obtaining indication information, the UE estimates its own TA, which is denoted as TAₑₛₜ, according to the indicated method.

The estimation method of TAₑₛₜ is as described above. For example, according to the TA obtaining indication information indicating to obtain the TA estimate value based on the threshold value, the UE compares the measured RSRP with the RSRP threshold. If it is greater than the threshold, a smaller TA is selected, and if it is less than the threshold, a larger TA is selected;

For example, the method of obtaining TAₑₛₜ based on pathloss indicated based on TA obtaining indication information may be: first calculate the downlink (DL) pathloss PL (pathloss, PL), and then derive the distance d between the BS and the UE based on the relationship between free space PL and distance, and finally estimate TA, denoted as TAₑₛₜ based on the relationship between d and time.

$$P L = P r x - P t x = RSRP\_DL - reference power$$

$$PL = 20 log ( d ) + 20 log ( f ) - 147.55$$

$$d = {TA}_{est} * 16 * 3 * 1 e 8 / ( 15 K * 2048 )$$

where f is the carrier frequency of signal, RSRP DL is the power of the received reference signal in downlink measured by the UE side, and reference power is the reference signal power ss-PBCH-BlockPower, carried in the SIB.

For example, the method of obtaining TAₑₛₜ based on receiving time of SIB indicated based on TA obtaining indication information may be, the UE side determines the TA estimate value based on the receiving time of SIB1, and the specific method is as described above.
Step 3: UE decodes PDSCH carrying Mgs2 RAR data and obtains information required for RAR scheduled PUSCH transmission. The information includes the UE number, optional DMRS resource indication, TA, T-CRNTI, and UL Grant resources.

The UE obtains the UE number and the PDSCH RAR payload length that needs to be decoded by decoding the RAR, and performs parsing.

The UE obtains TA information, denoted as TA_{TAC}, by parsing the TAC field.

When absolute TA values are in the TAC field, the UE compares TAₑₛₜ with TA_{TAC}, selects the closest one among TA_{TAC} as its own TA value TA_{final}, and records the index TA_{final,i} of TA_{final} at the same time.

$${TA}_{final} = {min}_{{TA}_{TAC , i}} \vert {TA}_{est} - {TA}_{TAC , i} \vert , i = 0 , 1 , 2 , … N - 1$$

When S_{TA} and Δ_{TA} are in the TAC field, the UE calculates the relative TA value through TAₑₛₜ and S_{TA}; the closest Δ_{TA} is then selected as its own relative TA value delta_{TA}; finally, TA_{final} is obtained based on the relationship between delta_{TA} and the absolute TA value and the absolute TA value, and the index TA_{final,i} of TA_{final} is recorded at the same time.

$${delta}_{TA} = {min}_{{Δ}_{TA , i}} \vert {Δ}_{TA , i} - \frac{\vert {TA}_{est} - {S}_{TA} \vert}{{unit}_{TA}} \vert , i = 0 , 1 , 2 , … N - 1$$

$${TA}_{final} = {S}_{TA} \pm {delta}_{TA} \times {unit}_{TA}$$

$${TA}_{final , i} = {Δ}_{TA , i}$$

Among them, ‘+’ is used for TAs sorting in ascending order, where S_{TA} is the minimum TA; ‘−’ is used for TAs sorting in descending order, that is S_{TA} is the maximum TA.

The above method of selecting the closest TA value may also compare the difference between TAₑₛₜ and TA_{TAC} with a predefined threshold Thr_{TA}. When TAₑₛₜ−TA_{TAC}>Thr_{TA}, it is considered that there is no TA that meets the condition. At this time, the UE fails to obtain the TA and re-initiates random access; on the contrary, the UE successfully obtains TA_{final} and TA_{final,i}.

Optional DMRS resources, if carried, the UE selects the DMRS resource with index TA_{final,i} in the UE information.

The UE selects the T-CRNTI corresponding to the index TA_{final,i} in the T-CRNTI field.

The UE selects UL Grant information through the UL Grant field. Specifically, when the UL Grant is only configured with one set, the UE may read it directly; when orthogonal UL Grant resources are configured, the UE selects the UL Grant resource corresponding to the index TA_{final,i}.
Step 4: The UE obtains the RAR scheduled PUSCH scheduling information based on the result of decoding the response, and transmits the RAR scheduled PUSCH. After transmitting PUSCH, the UE will start the ra-ContentionResolutionTimer timer at the same time. Before the timer expires, the UE will continue monitoring the PDCCH of Msg4. If the timer expires, the UE considers that the contention has failed and re-initiates the random access procedure.

The UE performs TA adjustment according to the obtained TA value, and the UE saves the T-CRNTI for descrambling the DCI of PUSCH retransmission scheduled by RAR or the DCI of MSG4, and for scrambling processing of PUSCH transmission. The UE determines the configuration of PUSCH transmission and time-frequency domain resource information through the UL Grant.

This embodiment designs a method for how UEs receive RAR in a multi-UE scenario, which ensures that UEs correctly obtain their own information and do not interfere with each other. It is the key to ensuring that conflicting UEs access simultaneously.

In this embodiment, by designing the method for the UE to estimate or obtain TA, it is the key time synchronization information for the UE to perform PUSCH transmission.

This embodiment designs a method of obtaining the corresponding T-CRNTI, UL Grant, and optional DMRS through TA information, which speeds up the time for the UE to obtain the information required for PUSCH transmission and reduces UE power consumption.

In this embodiment, the UE obtains RAPID in the PDCCH, ensuring that the UE obtains its own TA in advance, improving the efficiency of decoding RAR, and reducing UE power consumption.

One or more embodiments provide the method for the UE side to receive the random access response RAR and obtain information of PUSCH transmission scheduled based on RAR in a multi-UE scenario. The information of PUSCH transmission includes the UE number, optional DMRS resource indication, TA, TA obtaining indication information, T-CRNTI, and UL Grant resources.

The UE receives RAR, steps involved are not repeated here as they have been described above.

For the Step 2 therein, when the PDCCH carries RAPID, UE number, and TA obtaining indication information:

The UE parses the M×(6+log₂ N) least significant bits of the PDCCH and checks whether the RAPID therein matches the RAPID transmitted by itself. If it matches, the UE obtains the corresponding UE number and calculates the PDSCH RAR payload range that needs to be decoded. In addition, according to the TA obtaining indication information, the UE will estimate its own TA, which is denoted as TAₑₛₜ, according to the indicated method which has been described above.
Step 3: the UE decodes PDSCH carrying Mgs2 RAR data and obtains information required for RAR scheduled PUSCH transmission. The information includes optional DMRS resource indication, TA, T-CRNTI, and UL Grant resources.

In this embodiment, the UE obtains the UE number in the PDCCH, which ensures that the UE obtains the PDSCH decoding range in advance, improves the efficiency of decoding RAR, and reduces UE power consumption.

One or more embodiments provide the method for the UE side to receive the random access response RAR and obtain information of PUSCH transmission scheduled based on RAR in a multi-UE scenario proposed by the present invention. The information of PUSCH transmission includes the UE number, optional DMRS resource indication, TA, TA obtaining indication information, T-CRNTI, and UL Grant resources.

The UE receives RAR, steps involved are not repeated here as they have been described above.

For the Step 2 therein, when the PDCCH carries RAPID, UE number, TA obtaining indication information and S_{TA}:

The UE parses the M×(18+log₂ N) least significant bits of the PDCCH and checks whether the RAPID therein matches the RAPID transmitted by itself. If it matches, the UE obtains the corresponding UE number and calculates the PDSCH RAR payload range that needs to be decoded; in addition, according to the TA obtaining indication information, the UE will estimate its own TA, which is denoted as TAₑₛₜ, according to the indicated method, which has been described above; at the same time, the UE may obtain the difference between TAₑₛₜ and S_{TA}. When the PDSCH TAC field carries the absolute TA values, Δ_{TA,est}=|TAₑₛₜ−S_{TA}|; When PDSCH TAC field carries Δ_{TA},

$${Δ}_{TA , est} = \frac{\vert T {A}_{est} - {S}_{TA} \vert}{{unit}_{TA}} .$$

Step 3: UE decodes PDSCH carrying Mgs2 RAR data and obtains information required for RAR scheduled PUSCH transmission. The information includes optional DMRS resource indication, remaining N−1 TAs, T-CRNTI, and UL Grant resources.

In this embodiment, the UE acquires S_{TA} in the PDCCH, ensuring that the UE acquires Δ_{TA,est} in advance, improves the efficiency of decoding RAR, and reduces UE power consumption.

One or more embodiments provide the method for the UE side to receive the random access response RAR and obtain information of PUSCH transmission scheduled based on RAR in a multi-UE scenario proposed by the present invention. The information of PUSCH transmission includes the UE number, optional DMRS resource indication, TA, TA obtaining indication information, T-CRNTI, and UL Grant resources.

The UE receives RAR, steps involved are not repeated here as they have been described above.

For the Step 2 therein, after the UE successfully decodes the PDCCH, it will obtain the RB resource information of the PDSCH RAR to receive the downlink transport block transmitted through the PDSCH, that is, the PDCCH does not carry UE detection related information, then the UE proceeds to step 3.
Step 3: UE decodes PDSCH carrying Mgs2 RAR data and obtains information required for RAR scheduled PUSCH transmission. The information includes the UE number, optional DMRS resource indication, TA, TA obtaining indication information, T-CRNTI, and UL Grant resources.

This embodiment, by the UE decoding the information of PUSCH transmission scheduled based on RAR in the PDSCH, enables multiple UEs to successfully receive multi-RAR, which is the key to ensuring multiple UEs access simultaneously.

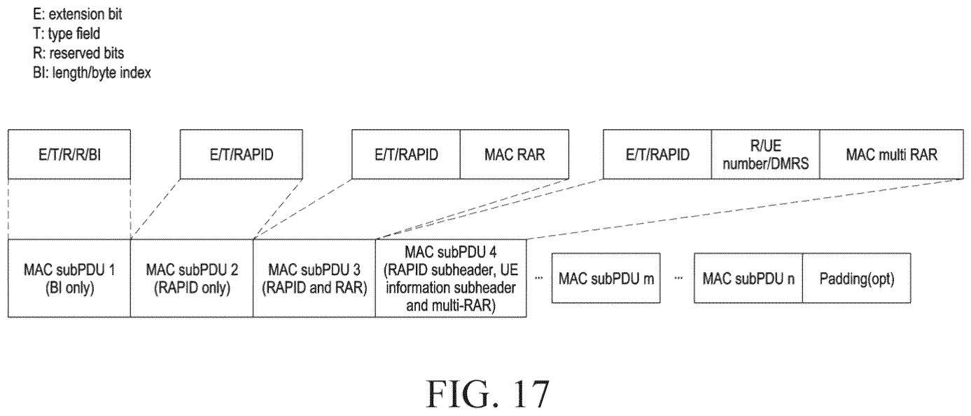

FIG. 18 illustrates a schematic structural diagram of a user equipment 1600 according to at least one embodiment of the present disclosure. Referring to FIG. 18, the user equipment 1600 includes a transceiver 1601 and a controller 1602. The transceiver 1601 is configured to transmit data or signals and to receive data or signals. The controller 1602 is coupled with the transceiver 1601 and configured to perform control such that the user equipment 1600 performs a method according to an embodiment of the present disclosure. In an implementation, the user equipment 1600 may also include a memory (not shown) on which computer-executable instructions are stored. When the instructions are executed by the controller 1602, the user equipment 1600 may perform at least one method corresponding to the above-mentioned embodiments of the present disclosure.

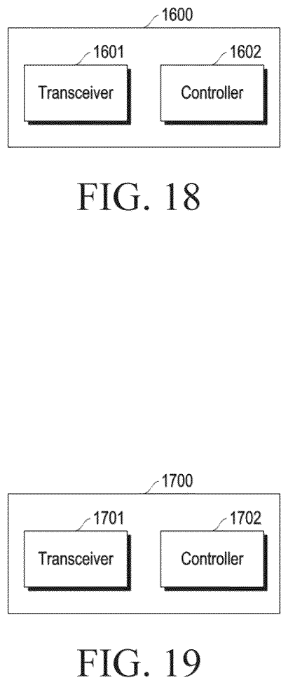

FIG. 19 illustrates a schematic structural diagram of a network node 1700 according to at least one embodiment of the present disclosure. Referring to FIG. 19, the network node 1700 includes a transceiver 1701 and a controller 1702. The transceiver 1701 is configured to transmit data or signals and to receive data or signals. The controller 1702 is coupled with the transceiver 1701 and is configured to perform control such that the network node 1700 performs methods according to embodiments of the present disclosure. In an implementation, the network node 1700 may also include a memory (not shown) on which computer-executable instructions are stored. When the instructions are executed by the controller 1702, the network node 1700 may perform at least one method corresponding to the above-mentioned embodiments of the present disclosure. The network node may be, for example, a base station or other network side device.

In one or more embodiments, a method performed by a user equipment (UE) in a communication system, may include: transmitting a random access request to a base station; receiving, from the base station, a response message including information for a plurality of UEs including the UE, wherein the information may include a plurality of timing advance (TA) information entries and corresponding resource allocation information; obtaining TA information and resource allocation information corresponding to the UE from the response message, from among the information for the plurality of UEs; and transmitting uplink transmission to the base station based on the obtained TA information and resource allocation information.

The response message may include at least one of: information of a number of the TA information entries; indication information of TA-related information, which indicates the UE to obtain corresponding TA-related information; random access preamble identification information; or a temporary cell radio network temporary identifier (T-CRNTI).

The response message may include information about a number of the plurality of UEs, and the method may include: decoding the response message based on the information about the number of the plurality of UEs.

The obtaining the TA information and the resource allocation information corresponding to the UE may include: obtaining TA-related information of the UE; and obtaining the TA information and the resource allocation information corresponding to the UE from the random access request based on the TA-related information, wherein the TA-related information may include at least one of: a downlink pathloss between the UE and the base station; a receiving time and a transmitting time of a system information block; or signal strength information and threshold information.

The obtaining the TA information and the resource allocation information corresponding to the UE may include: determining TA estimation information of the UE; determining, among the plurality of TA information entries included in the response message, the TA information having a least difference from the TA estimation information as the TA information of the UE.

The TA-related information may include the downlink pathloss between the UE and the base station. The determining the TA estimation information of the UE may include: determining first TA estimation information corresponding to the UE based on the downlink pathloss between the UE and the base station.

The TA-related information may include the receiving time and the transmitting time of the system information block, and wherein the determining the TA estimation information of the UE may include: determining second TA estimation information corresponding to the UE based on the receiving time and the transmitting time of the system information block.

The method may include: receiving the system information block transmitted from the base station, the system information block including the transmitting time.

The TA-related information may include the signal strength information and the threshold information. The determining the TA estimation information of the UE may include: determining signal strength information of the UE; and determining third TA estimation information corresponding to the UE based on a signal strength interval corresponding to the signal strength information of the UE.

The threshold information may include first threshold information and threshold offset information. The method may include: determining multiple signal strength intervals based on the first threshold information and the threshold offset information.

The signal strength information may include reference signal received power (RSRP).

The plurality of TA information entries may include: one first TA information and a plurality of second TA information. The first TA information indicates a reference TA value corresponding to the UE among the plurality of UEs, and each of the second TA information indicates a relative TA value with respect to the first TA information for another UE among the plurality of UEs.

The determining the TA information having the least difference from the TA estimation information, may include: determining third TA information based on the TA estimation information and the first TA information; and determining the TA information of the UE based on second TA information having a least difference from the third TA information among the plurality of second TA information.

The resource allocation information for the plurality of UEs may include: one uplink grant information and a plurality of demodulation reference signal (DMRS) information for the plurality of UEs.

The obtaining the TA information and the resource allocation information corresponding to the UE may include: determining DMRS information corresponding to the UE among the plurality of DMRS information based on the obtained TA information corresponding to the UE; and determining port information for transmitting uplink transmission based on the DMRS information corresponding to the UE.

The response message may include a random access response (RAR).

The response message may include downlink control information (DCI) including at least one of: information about a number of the plurality of TA information entries; indication information of TA-related information, which indicates the UE to obtain corresponding TA-related information; random access preamble identification information; or first TA information. The information about the number of the plurality of TA information entries may include the first TA information and a plurality of second TA information. The first TA information indicates a reference TA value corresponding to the UE among the plurality of UEs, and each of the second TA information indicates a relative TA value with respect to the first TA information for another UE among the plurality of UEs.

In one or more embodiments, a user equipment (UE) in a communication system, may include: a transceiver configured to transmit and receive signals; a memory storing one or more instructions; and a processor configured to execute the one or more instructions to: transmit a random access request to a base station; receive, from the base station, a response message including information for a plurality of UEs including the UE, wherein the information may include a plurality of timing advance (TA) information entries and corresponding resource allocation information; obtain TA information and resource allocation information corresponding to the UE from the response message, from among the information for the plurality of UEs; and transmit uplink transmission to the base station based on the obtained TA information and resource allocation information.

In one or more embodiments, there is provided a non-transitory computer-readable storage medium storing a program that is executable by a computer to perform a method for controlling a user equipment (UE) in a communication system. The method may include: transmitting a random access request to a base station; receiving, from the base station, a response message including information for a plurality of UEs including the UE, wherein the information may include a plurality of timing advance (TA) information entries and corresponding resource allocation information; obtaining TA information and resource allocation information corresponding to the UE from the response message, from among the information for the plurality of UEs; and transmitting uplink transmission to the base station based on the obtained TA information and resource allocation information.

The above description is only an exemplary embodiment of the present invention and is not intended to limit the present invention. Any modifications, equivalent substitutions, improvements, etc. made within the spirit and principles of the present invention should be included in the protection scope of the present invention.

Those skilled in the art will appreciate that the present invention includes reference to devices for performing one or more of the operations described herein. These devices may be specially designed and manufactured for the required purposes, or they may comprise known devices found in general purpose computers. These devices have computer programs stored therein that are selectively activated or reconfigured. Such a computer program may be stored in a device (e.g., a computer) readable medium, including, but not limited to, any type of disk including a floppy disk, a hard disk, an optical disk, a CD-ROM, and a magnetic-optical disk, a Read-Only Memory (ROM), a Random Access Memory (RAM), an Erasable Programmable Read-Only Memory (EPROM), an Electrically Erasable Programmable Read-Only Memory (EEPROM), a flash memory, a magnetic card, or an optical card, or in any type of media suitable for storing electronic instructions, respectively coupled to a bus. That is, a readable medium includes any medium that stores or transmits information in a form readable by a device (e.g., a computer).

It will be understood by those skilled in the art that each block of the structural diagrams and/or block diagrams and/or flow diagrams, and combinations of blocks in the structural diagrams and/or block diagrams and/or flow diagrams, may be implemented by computer program instructions. Those skilled in the art may understand that these computer program instructions may be provided to a processor of a general-purpose computer, a special-purpose computer, or other programmable data processing method for implementation, so that the solution specified in the structural diagrams and/or block diagrams and/or flow diagrams disclosed in the present embodiments may be executed by the processor of the computer or other programmable data processing method.

While not restricted thereto, the operations or steps of the methods or algorithms according to the above example embodiments may be embodied as computer-readable codes on a computer-readable recording medium. The computer-readable recording medium may be any recording apparatus capable of storing data that is read by a computer system. Examples of the computer-readable recording medium include read-only memories (ROMs), random-access memories (RAMs), CD-ROMs, magnetic tapes, floppy disks, and optical data storage devices. The computer-readable recording medium may be a carrier wave that transmits data via the Internet, for example. The computer-readable medium may be distributed among computer systems that are interconnected through a network so that the computer-readable code is stored and executed in a distributed fashion. Also, the operations or steps of the methods or algorithms according to the above example embodiments may be written as a computer program transmitted over a computer-readable transmission medium, such as a carrier wave, and received and implemented in general-use or special-purpose digital computers that execute the programs. Moreover, it is understood that in example embodiments, the above-described apparatuses and devices can include or implemented by circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method performed by a user equipment (UE) in a communication system, the method comprising:
transmitting a random access request to a base station;
receiving, from the base station, a response message in response to the random access request wherein the response message comprises information about a plurality of timing advance (TA) information entries and corresponding resource allocation information for a plurality of UEs;
obtaining TA information and resource allocation information corresponding to the UE based on the response message; and
transmitting uplink transmission to the base station based on the obtained TA information and the obtained resource allocation information corresponding to the UE.

2. The method of claim 1, wherein the response message further comprises at least one of:
information of a number of the TA information entries;
indication information of TA-related information, which indicates the UE to obtain corresponding TA-related information;
random access preamble identification information; or
a temporary cell radio network temporary identifier (T-CRNTI).

3. The method of claim 1, wherein the obtaining the TA information and the resource allocation information corresponding to the UE comprises:
obtaining TA-related information of the UE; and
obtaining the TA information and the resource allocation information corresponding to the UE from the response message based on the TA-related information,
wherein the TA-related information comprises at least one of:
a downlink pathloss between the UE and the base station;
a receiving time and a transmitting time of a system information block; or
signal strength information and threshold information.

4. The method of claim 3, wherein the obtaining the TA information and the resource allocation information corresponding to the UE comprises:
determining TA estimation information of the UE based on the TA-related information; and
determining, among the plurality of TA information entries included in the response message, TA information having a least difference from the TA estimation information as the TA information of the UE.

5. The method of claim 3, further comprising:
receiving the system information block transmitted from the base station, the system information block comprising the transmitting time.

6. The method of claim 3, wherein the threshold information comprises first threshold information and threshold offset information, and
wherein the method further comprises: determining multiple signal strength intervals based on the first threshold information and the threshold offset information.

7. The method of claim 3, wherein the signal strength information comprises reference signal received power (RSRP).

8. The method of claim 5, wherein the plurality of TA information entries comprises:
information about a first TA and information about a plurality of second TAs,
wherein the information about the first TA indicates a reference TA value corresponding to the UE among the plurality of UEs, and the information about the plurality of second TAs indicates a relative TA value with respect to the first TA information for each UE among the plurality of UEs.

9. The method of claim 8, wherein the determining the TA information having the least difference from the TA estimation information, comprises:
determining information about a third TA based on the TA estimation information and the first TA information; and
determining the TA information of the UE based on a second TA having a least difference from the third TA among the plurality of second TAs.

10. The method of claim 1, wherein the resource allocation information for the plurality of UEs comprises:
uplink grant information and information about a plurality of demodulation reference signals (DMRSs) for the plurality of UEs.

11. The method of claim 10, wherein the obtaining the TA information and the resource allocation information corresponding to the UE comprises:
determining DMRS information corresponding to the UE from the information about the plurality of DMRSs based on the obtained TA information corresponding to the UE; and
determining port information for transmitting uplink transmission based on the DMRS information corresponding to the UE.

12. The method of claim 1, wherein the response message comprises a random access response (RAR).

13. The method of claim 1, wherein the response message comprises downlink control information (DCI) comprising at least one of:
information about a number of the plurality of TA information entries;
indication information of TA-related information, which indicates the UE to obtain corresponding TA-related information;
random access preamble identification information; or
information about a first TA,
wherein the information about the number of the plurality of TA information entries comprises the information about the first TA and information about a plurality of second TAs, and
wherein the information about the first TA indicates a reference TA value corresponding to the UE among the plurality of UEs, and the information about the plurality of second TAs indicates a relative TA value with respect to the first TA information for each UE among the plurality of UEs.

14. A user equipment (UE) in a communication system, the UE comprising:
memory storing instructions; and
at least one processor operably coupled to the memory, wherein the instructions, when executed by the at least one processor individually or collectively, cause the UE to perform operations, the operations comprising:
transmitting a random access request to a base station;
receiving, from the base station, a response message in response to the random access request wherein the response message comprises information about a plurality of timing advance (TA) information entries and corresponding resource allocation information for a plurality of UEs;
obtaining TA information and resource allocation information corresponding to the UE based on the response message; and
transmitting uplink transmission to the base station based on the obtained TA information and the obtained resource allocation information corresponding to the UE.

15. The UE of claim 14, wherein the response message further comprises at least one of:
information of a number of the TA information entries;
indication information of TA-related information, which indicates the UE to obtain corresponding TA-related information;
random access preamble identification information; or
a temporary cell radio network temporary identifier (T-CRNTI).

16. The UE of claim 14, wherein the obtaining the TA information and the resource allocation information corresponding to the UE comprises:
obtaining TA-related information of the UE; and
obtaining the TA information and the resource allocation information corresponding to the UE from the response message based on the TA-related information,
wherein the TA-related information comprises at least one of:
a downlink pathloss between the UE and the base station;
a receiving time and a transmitting time of a system information block; or
signal strength information and threshold information.

17. The UE of claim 16, wherein the obtaining the TA information and the resource allocation information corresponding to the UE comprises:
determining TA estimation information of the UE based on the TA-related information; and
determining, among the plurality of TA information entries included in the response message, TA information having a least difference from the TA estimation information as the TA information of the UE.

18. The UE of claim 14, wherein the resource allocation information for the plurality of UEs comprises:
uplink grant information and information about a plurality of demodulation reference signals (DMRSs) for the plurality of UEs.

19. The UE of claim 14, wherein the response message comprises downlink control information (DCI) comprising at least one of:
information about a number of the plurality of TA information entries;
indication information of TA-related information, which indicates the UE to obtain corresponding TA-related information;
random access preamble identification information; or
information about a first TA,
wherein the information about the number of the plurality of TA information entries comprises the information about the first TA and information about a plurality of second TAs, and
wherein the information about the first TA indicates a reference TA value corresponding to the UE among the plurality of UEs, and the information about the plurality of second TAs indicates a relative TA value with respect to the first TA information for each UE among the plurality of UEs.

20. A non-transitory computer-readable storage medium storing instructions which, when executed by at least one processor of a user equipment (UE) individually or collectively, cause the UE to perform operations, the operations comprising:
transmitting a random access request to a base station;
receiving, from the base station, a response message in response to the random access request wherein the response message comprises information about a plurality of timing advance (TA) information entries and corresponding resource allocation information for a plurality of UEs;
obtaining TA information and resource allocation information corresponding to the UE based on the response message; and
transmitting uplink transmission to the base station based on the obtained TA information and the obtained resource allocation information corresponding to the UE.
